(19) United States
(12) Patent Application Publication
(10) Pub. No.: US 2025/0301528 A1
(43) Pub. Date: Sep. 25, 2025

(54) DIRECTIONAL SD-WAN TRANSPORT/STREAM BLACKOUT/BROWNOUT CLASSIFICATION

(71) Applicant: Hughes Network Systems, LLC, Germantown, MD (US)

(72) Inventors: Douglas Merrill DILLON, Rockville, MD (US); Solomon Emirie KASSAHUN, Gaithersburg, MD (US)

(73) Assignee: Hughes Network Systems, LLC, Germantown, MD (US)

(21) Appl. No.: 18/612,684

(22) Filed: Mar. 21, 2024

(51) Int. Cl. H04W 76/22; H04L 12/46; H04W 24/08; H04W 84/06; H04W 88/16

(52) U.S. Cl. CPC H04W 76/22; H04L 12/4633; H04W 24/08; H04W 84/06; H04W 88/16

(57) ABSTRACT

Systems, methods, and apparatuses are disclosed for selecting a directional Software Defined Wide Area Network (SD-WAN) transport/stream to transmit packets of a unidirectional Internet Protocol (IP) flow over one or more WAN transports between an SD-WAN router and an SD-WAN gateway. In one example, the SD-WAN router and the SD-WAN gateway maintain a multitude of SD-WAN tunnels on at least two different types of WAN transports (such as, e.g., a satellite-based, a cellular telecommunication-based, and/or an Internet-based type). Each SD-WAN tunnel has an upstream directional SD-WAN transport/stream and a downstream directional SD-WAN transport/stream. In one example, an SD-WAN device receives packets to transmit in a specific direction on an SD-WAN communication connection and selects, to transmit the received packets, a directional SD-WAN transport/stream from among the active directional SD-WAN transport/streams in that specific direction on all of the WAN transports, based on its operational status (e.g., CLEAN, BROWNOUT, or BLACKOUT).

### TECHNICAL FIELD

This patent application is directed generally to the field of networking technology and, more specifically, to systems, methods, and apparatuses for improving connectivity by directing packets in a Software Defined Wide Area Network (SD-WAN) over a multitude of WAN transports carried on a multitude of different communication systems, including, e.g., satellite systems, cellular telephony systems, and the Internet.

### BACKGROUND

Different types of communication connections may have significantly different properties. For example, different access systems, such as, e.g., cellular, satellite, coaxial cable, fiber optic cable, digital subscriber line (DSL), and the like, may provide different performance characteristics (such as, e.g., latency, throughput, packet loss, and the like), and in some cases these performance characteristics may vary over time. Moreover, different applications, services, transfers, and the like carried by communication connections may require different performance characteristics, which may also vary over time and/or vary depending on the situation. For example, streaming media, bulk file transfers, and/or web browsing may each require a separate and distinct set of performance characteristics.

In the field of broadband access technology, two common types of service are: (1) cellular telephony service (hereinafter referred to as Long Term Evolution, or “LTE”); and (2) High-Throughput Satellite (HTS) service, which may use a system of geosynchronous satellites. As broadband services, both the LTE service and the HTS service may suffer from related and different communication problems, involving performance characteristics such as, for example, speed, throughput, latency, dropped packets, capacity, jitter, and the like, as would be understood by one of ordinary skill in the art. Because of these constraints, different techniques (such as, for example, metering) have been developed for controlling and/or managing usage, capacity, traffic, and the like, of LTE and HTS connections.

One technique may be to establish a Virtual Private Network (VPN), where a virtual network is created by using encrypted packets over the communication connection so that intermediate networking devices (such as, e.g., routers, gateways, and the like) may not identify the Internet Protocol (IP) flow, application, content, and the like, of the packet. In some implementations, a VPN may be employed by a corporate enterprise network so that a home office worker may connect over public and/or any other relatively open networks, such as, e.g., the Internet, with the employer's private, secured servers. By such a VPN, the home worker may securely access/employ a variety of applications, including, for example, video conferencing, document sharing, email, centralized file storage, and the like, of the corporate enterprise network.

Another technique may be a Software Defined Wide Area Network (SD-WAN), which allows software defined policies to be applied on the basis of, for example, application, device, connection, end-user, usage, and the like, to the selection of WAN access technology and/or WAN transport to be used to carry that traffic. SD-WAN may use a technology where an SD-WAN router at, for example, a customer's premises maintains a tunnel for each of its WAN connections to an SD-WAN gateway.

Generally speaking, any system, method, or apparatus which may provide, for example, more flexible, more efficient, and/or more cost-effective provisioning of network resources for SD-WAN connections may be beneficial.

### SUMMARY

This summary is provided to introduce a selection of concepts, in a simple manner, which are further described in the detailed description. This summary is neither intended to identify key or essential inventive concepts of the subject matter nor to determine and/or circumscribe the scope of the subject matter herein in any way.

In one aspect, the present disclosure provides a software defined wide area network (SD-WAN) device, which includes a first SD-WAN interface (with a first WAN connection), a second SD-WAN interface (with a second WAN connection), a processor operatively coupled to the first and second SD-WAN interfaces, and a memory operatively coupled with the processor. The processor maintains first and second SD-WAN tunnels over the first and second WAN connections, respectively, where each of the SD-WAN tunnels includes a directional SD-WAN transport/stream in a first direction (e.g., upstream) and a directional SD-WAN transport/stream in a second direction (e.g., downstream). The SD-WAN device may receive a multitude of packets from a first remote host to be transmitted to a second remote host. The memory stores executable instructions which, when executed by the processor, cause the processor to perform certain steps, including: determining the transmission direction of the received multitude of packets, determining the operational status (e.g., CLEAN, BROWNOUT, or BLACKOUT) of each of the directional SD-WAN transport/streams in the determined direction, and selecting a directional SD-WAN transport/stream to transmit the multitude of packets in the determined direction based on its determined operational status. In some implementations, the first WAN connection may include a satellite network (such as, e.g., an HTS service network) and the second WAN connection may include a wireless cellular network (such as, e.g., an LTE service network).

In another aspect, the present disclosure provides a method for assigning a directional software defined wide area network (SD-WAN) transport/stream to SD-WAN packet traffic, including the steps of: determining an applicable criteria for classification for each directional SD-WAN transport/stream being carried in any SD-WAN tunnel on any of a multitude of WAN transports between two or more SD-WAN devices; monitoring and calculating the operational status (e.g., CLEAN, BROWNOUT, or BLACKOUT) for each active directional SD-WAN transport/stream; and selecting an active directional SD-WAN transport/stream to transmit outgoing SD-WAN packet traffic, based on its calculated operational status. In some implementations, the applicable criteria for classification may include a set of packet traffic characteristics that define the operational status of each directional SD-WAN transport/stream such as, for example, traffic direction, connectivity, capacity, packet loss, latency, service classification, Quality of Service (QOS), jitter, cost, reliability, transport mode, or traffic type. As used herein, like in common English usage, the term “criteria” may refer to either or both the singular (“criterion”) and the plural, similarly to how the terms “agenda” and “data” are commonly, concisely, and clearly used for both the singular and the plural in English usage.

In yet another aspect, the present disclosure provides a non-transitory computer storage medium having machine-readable instructions which, when executed by a processor, instructs the processor to perform a series of steps for selecting a directional software defined wide area network (SD-WAN) transport/stream to transmit a received multitude of packets based on the determined operational status (e.g., CLEAN, BROWNOUT, or BLACKOUT) of the directional SD-WAN transport/stream. In some implementations, the multitude of packets are being transmitted over an SD-WAN communication connection between a first remote host communicatively connected to an SD-WAN router and a second remote host communicatively connected to an SD-WAN gateway. The SD-WAN router and the SD-WAN gateway may be connected by a first WAN connection which includes a satellite network and a second WAN connection which includes a wireless cellular network, and the SD-WAN router and the SD-WAN gateway may maintain the SD-WAN communication connection over one or more SD-WAN tunnels on the first and second WAN connections. Each of the one or more SD-WAN tunnels includes a directional SD-WAN transport/stream in a first direction (e.g., upstream) and a directional SD-WAN transport/stream in a second direction (e.g., downstream).

In some implementations, the series of steps performed by the processor include: receiving the multitude of packets to transmit on the SD-WAN communication connection; determining a transmission direction and an application group for the received multitude of packets; selecting, based on the determined application group, a set of packet traffic characteristics which define an operational status of a directional SD-WAN transport/stream, and determining, based on the selected set of packet traffic characteristics, an operational status of all of the directional SD-WAN transport/streams in the determined direction.

To further clarify the features of the present disclosure, a more particular description follows by reference to specific embodiments or examples thereof, which are illustrated in the appended figures. It is to be appreciated that these figures depict only some examples and/or implementations of the present disclosure and are therefore not to be considered limiting in scope. Examples and/or implementations of the present disclosure will be described and explained with additional specificity and detail below with reference to the appended figures.

### BRIEF DESCRIPTION OF DRAWINGS

Features of the present disclosure are illustrated by way of example and not limited in the following figure(s), in which like numerals indicate like elements, in which:

FIG. 1A is a block diagram illustrating a Software Defined Wide Area Network (SD-WAN) communication system with multiple Wide Area Network (WAN) transports over a satellite-based system, a cellular communication system, and the Internet, to which the described examples may be applied.

FIG. 1B is a further simplified block diagram illustrating the SD-WAN communication system of FIG. 1A, to which the described examples may be applied.

FIGS. 1C and 1D are block diagrams showing the SD-WAN communication system of FIGS. 1A and 1B, and illustrating two different connections over different WAN transports to different end users, to which the described examples may be applied.

FIG. 2A is a block diagram illustrating an SD-WAN communication system having directional WAN transport/stream classification, according to examples.

FIG. 2B is a block diagram illustrating an SD-WAN Router capable of routing unidirectional IP flows on directional SD-WAN transport/streams over WAN transports, according to examples.

FIG. 2C is a block diagram illustrating an SD-WAN Gateway capable of routing unidirectional IP flows on directional SD-WAN transport/streams over WAN transports, according to examples.

FIG. 3 illustrates a flow diagram of a method of directional SD-WAN transport/stream path selection for the packets of an IP flow, according to an example.

FIG. 4 is a block diagram illustrating the SD-WAN communication system of FIGS. 2A-2C separately routing the upstream and the downstream of a single communication connection over separate directional SD-WAN transport/streams on different WAN transports, according to an example.

FIG. 5 is a table showing a set of packet traffic performance characteristics for defining the operational status of each directional SD-WAN transport/stream, according to an example.

FIG. 6 is a state diagram illustrating when path selection may be performed in a directional SD-WAN transport/stream classification system, according to an example.

FIG. 7 illustrates a flow diagram of a method of directional SD-WAN transport/stream path selection in an SD-WAN communication system, according to an example.

FIG. 8 illustrates a flow diagram of a method for selecting/assigning a directional SD-WAN transport/stream to SD-WAN packet traffic based on operational status, according to an example.

FIG. 9 illustrates a flow diagram of a method for selecting/assigning a directional SD-WAN transport/stream to SD-WAN packet traffic based on operational status, according to an example.

FIG. 10 illustrates a flow diagram of a method for selecting/assigning a directional SD-WAN transport/stream to SD-WAN packet traffic based on operational status, according to an example.

FIG. 11 illustrates a computer system in which or with which examples may be implemented.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples and/or implementations of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples, implementations, and/or embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms “a” and “an” are intended to denote at least one of a particular element, the term “includes” means includes but not limited to, the term “including” means including but not limited to, and the term “based on” means based at least in part on, the term “based upon” means based at least in part upon, and the term “such as” means such as but not limited to. The term “relevant” means closely connected or appropriate to what is being performed or considered.

Unless otherwise defined, all technical and scientific terms used herein have the same meaning as commonly understood by those skilled in the art to which this disclosure belongs. The system, methods, apparatuses, implementations, and examples and/or implementations provided herein are only illustrative and not intended to be limiting.

The present disclosure describes systems, methods, and apparatuses for selecting a directional Software Defined Wide Area Network (SD-WAN) transport/stream to transmit packets of a unidirectional Internet Protocol (IP) flow over one or more WAN transports between an SD-WAN router and an SD-WAN gateway. In some implementations, a separate operational status (e.g., CLEAN, BROWNOUT, or BLACKOUT) may be assigned to the upstream and the downstream of each WAN transport (such as, e.g., a WAN transport over a satellite-based network, a cellular telecommunications-based network, and/or the Internet) between two or more SD-WAN devices in an SD-WAN communication system.

In actual experience with SD-WAN systems, the operational health/status (i.e., the performance characteristics) of the upstream of a WAN transport may differ significantly from the operational health/status of the downstream of the same WAN transport. For instance, the upstream capacity of an LTE WAN transport may be extremely low, e.g., around 20 kbps, while at the same time the downstream capacity of the same LTE WAN transport may be relatively high, e.g., around 10 Mbps. Similarly, the upstream packet loss of a WAN transport may be relatively high, while at the same time the downstream packet loss of the same WAN transport may be relatively low. Because of this, it may be disadvantageous, for example, to classify an entire WAN transport as unhealthy, when it may have relatively healthy performance metrics in the upstream, but relatively unhealthy performance metrics in the downstream.

According to implementations and/or examples of the present disclosure, rather than classifying each WAN transport as a whole (i.e., both the upstream and the downstream), the operational status of each directional stream (i.e., the upstream and the downstream) may be separately classified and then assessed and/or considered separately for the routing/transmission of SD-WAN packet traffic. Accordingly, the different directional streams, i.e., the upstream and the downstream, may be referred to herein as “directional transport/streams” or “directional SD-WAN transport/streams” to distinguish them from whole/entire SD-WAN tunnels and/or whole/entire WAN transports (which include both the upstream and the downstream).

For instance, in an implementation where the SD-WAN system has a satellite-based WAN transport and a terrestrial cellular telecommunication-based WAN transport, it may be useful to assign packet traffic travelling in one direction of an SD-WAN communication connection to a directional SD-WAN transport/stream in that direction on the satellite-based WAN transport, while assigning the packet traffic of the same SD-WAN communication connection in the other direction to a directional SD-WAN transport/stream in the other direction on the terrestrial cellular telecommunication-based WAN transport. This may be particularly useful when, for example, the reduced latency of the terrestrial cellular telecommunication-based WAN transport in one direction improves the responsiveness of the connection as perceived by the end-user.

While examples of WAN transports being terrestrial cellular telecommunication-based, satellite-based, Internet-based, etc., are described and discussed herein, the present disclosure is not limited in any way, shape, or form, to those examples, and systems, apparatuses, and methods described herein may be applied to any WAN transports of any sort of differing types of WAN transports (such as, for example, a GEO satellite-based WAN transport vs. a LEO-satellite-based WAN transport).

Accordingly, the systems, apparatuses, and methods described herein may increase network efficiency, as well as the Quality of Experience (QoE) for the end user, and reduce the waste of resources in an SD-WAN communication system which has both a satellite-based WAN transport and a terrestrial cellular telecommunication-based WAN transport. These and other benefits and advantages may be apparent in the examples and/or implementations outlined below.

Multi Network SD-WAN System with HTS and LTE WAN Transports

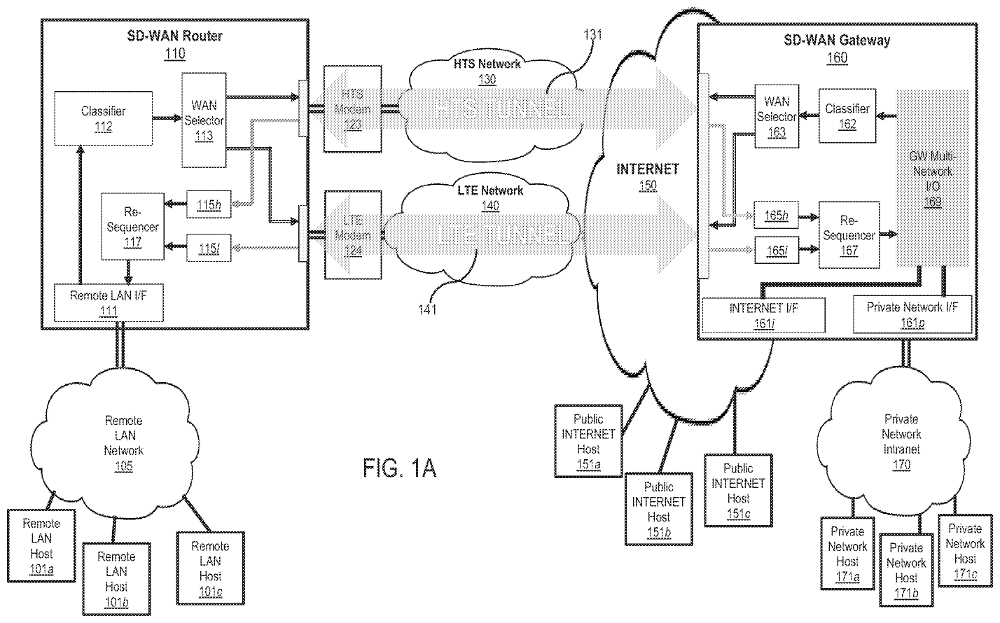

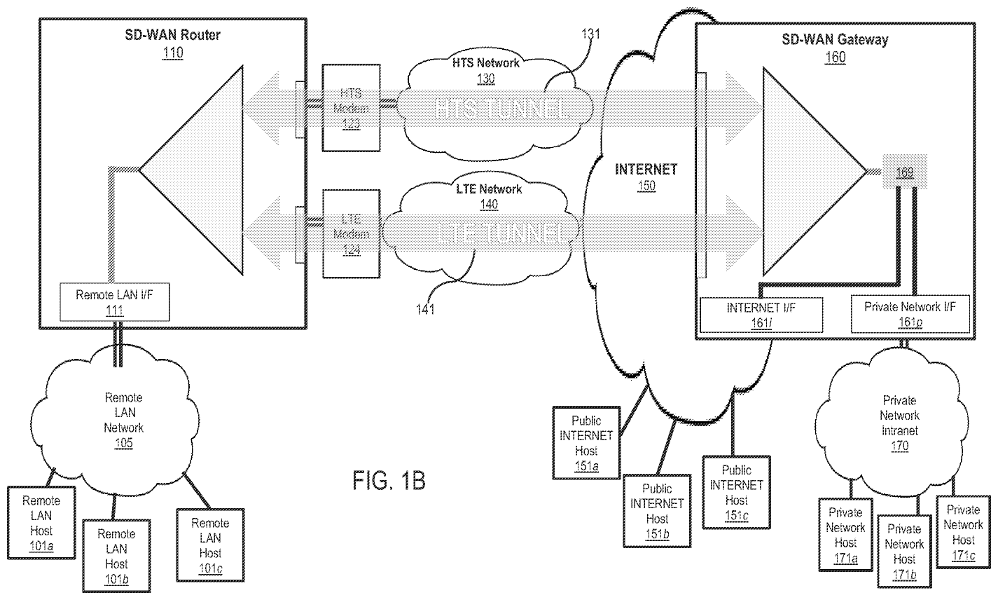

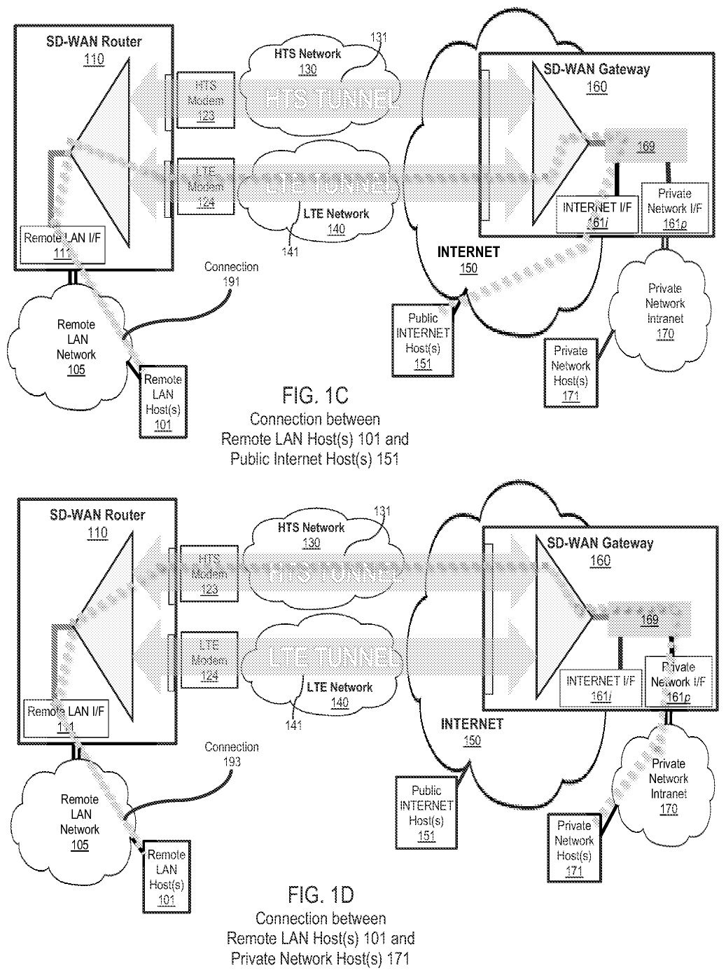

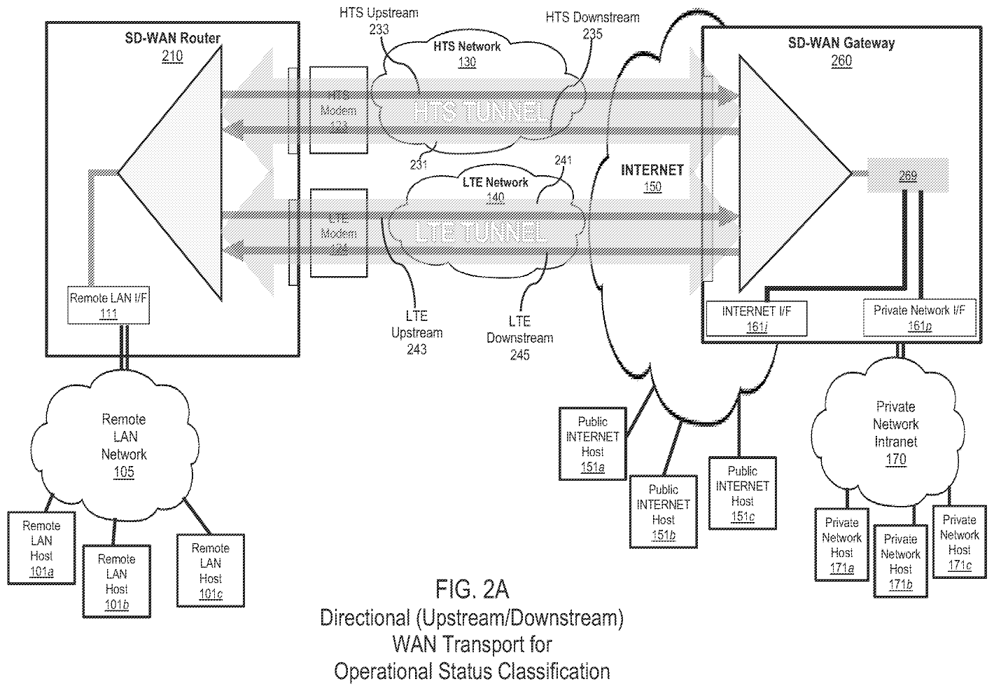

Software Defined Wide Area Network (SD-WAN) technologies may employ multiple broadband transports to provide improved network access to, e.g., one or more VPNs and/or the Internet, where the individual applications are carried by the WAN transport that is suitable/appropriate for that application given its network performance characteristics, such as, e.g., latency, throughput, and the like. Some SD-WAN technologies may provide a Quality of Service (QOS) overlay with multiple classes of service (e.g., different “priorities”) across broadband WAN transports which, in and of themselves, carry packets in a first-in, first-out fashion—i.e., without QoS. In some implementations and/or examples, this may be done by the SD-WAN router and the SD-WAN gateway which maintain the SD-WAN tunnels over the broadband WAN transports classifying the packets being transmitted, assigning the packets a priority and/or class-of-service, and running the packets through a priority queue governed by a rate limiter, which is tuned to avoid congesting the broadband WAN transport(s). A non-limiting example of this type of SD-WAN system is described below in relation to FIGS. 1A-1D.

In some implementations and/or examples, the multiple broadband transports employed by the SD-WAN system may include WAN transports on both a satellite-based network and a cellular telecommunication-based network, which are discussed in more detail below.

Satellite-based networking provides broadband access to many users around the world. For instance, geosynchronous satellite networking provides Internet access to more than a million users in the United States. Satellite-based networking may provide high-speed service where a wired terrestrial service (such as provided by, e.g., cable modem or fiber optic cable) is not available, but it may have a longer latency than terrestrial alternatives. For instance, a satellite-based network may provide a round-trip time (RTT) of roughly 600 ms to 900 ms, while a wired terrestrial service may have an RTT of under 100 ms. Accordingly, a satellite-based network may be less responsive than terrestrial access networks for latency-sensitive applications such as, e.g., web browsing, gaming, VPNs, and the like, but a satellite-based network may be more appropriate and/or suitable for carrying bulk transfers (such as, e.g., streaming video), as a satellite-based network may provide good performance for that type of application. Hereinafter, the term “High-Throughput Satellite system,” “HTS system,” and/or “HTS” may be used to refer to any sort of satellite-based network system that may provide broadband access (such as, e.g., WAN transports).

A cellular telecommunication-based network and/or a wireless cellular network also provides broadband access to many users around the world. Hereinafter, the term “Long Term Evolution system,” “LTE system,” and/or “LTE” may be used to refer to any sort of cellular-based network system that may provide broadband access (such as, e.g., WAN transports), including, but not limited to, any system using any version of the Third Generation Partnership Project (3GPP) standards (such as, e.g., 3G, LTE, 4G, 5G, 5GNR, 6G, and the like), or any other cellular/wireless standards from any other industry standards group, such as, e.g., the Open Radio Access Network (O-RAN) Alliance; the Institute of Electrical and Electronic Engineers (IEEE) (such as, e.g., the 802 series of standards); the International Telecommunications Union (ITU); the European Telecommunications Institute (ETSI); the Electronic Industries Alliance (EIA)/Telecommunication Industry Association (TIA); the International Electrotechnical Commission (IEC) (sometimes with the International Organization for Standardization (IOS/IEC)); and the like, as would be understood by one of ordinary skill in the art.

An LTE network may provide broadband access with reasonably low latency, thereby providing a suitable/adequate performance for latency-sensitive applications, but such LTE networks may have low bulk transfer rates and may have a usage cost that is typically an order of magnitude more expensive than an HTS service. This is just one example of the many differences in performance characteristics between an LTE service and an HTS service, as would be understood by one of ordinary skill in the art.

Accordingly, one implementation of an SD-WAN communication system may employ both a WAN transport over an HTS service (by maintaining an “HTS tunnel”) and a WAN transport over an LTE service (by maintaining an “LTE tunnel”). As discussed above, one of the responsibilities of such an SD-WAN communication system may be to appropriately route packet traffic onto either an HTS tunnel or an LTE tunnel based on network performance metrics combined with a classification system for the SD-WAN packet traffic.

FIG. 1A is a block diagram illustrating a Software Defined Wide Area Network (SD-WAN) communication system with multiple Wide Area Network (WAN) transports over a satellite-based system, a cellular communication system, and the Internet. The SD-WAN system depicted in FIG. 1A is provided as an example for purposes of illustrating aspects, features, characteristics, and/or components relevant and/or germane to implementations of the present disclosure, and thus, it should be appreciated that FIG. 1A may omit aspects, features, characteristics, and/or components not germane to implementations of the present disclosure, as would be understood by one of ordinary skill in the art; moreover, some of the aspects, features, characteristics, and/or components described herein may be removed from and/or modified in the SD-WAN system shown in FIG. 1A without departing from the scope of the implementations of the present disclosure, as would also be understood by one of ordinary skill in the art.

In FIG. 1A, any one or more of remote LAN Hosts 101a, 101b, and/or 101c may be connected to a Remote LAN 105 which, in turn, may be connected to an SD-WAN Router 110. Multiple remote LAN hosts, including the remote LAN Hosts 101a, 101b, and 101c, may be connected to the Remote LAN 105 and such remote LAN hosts may include any of a wide variety of consumer devices, communication devices, network terminals, and/or any number of network-enabled computing devices, elements, or systems, such as, e.g., a laptop, a tablet, a mobile phone, an appliance, a camera, a sensor, a thermostat, a vehicle, a display, and the like Moreover, any number of remote LANs in addition to the Remote LAN 105 may be connected to the SD-WAN Router 110.

The SD-WAN Router 110 may be connected to an HTS Network 130 by an HTS Modem 123 and to an LTE network 140 by an LTE Modem 124. Both the HTS Network 130 and the LTE network 140 may be connected to the Internet 150, whereby the SD-WAN Router 110 may access the Internet 150 through either the HTS Network 130 or the LTE Network 140. An SD-WAN Gateway 160 may be connected to the Internet 150, as well as any number of Public Internet Hosts 151a, 151b, and/or 151c. As would be understood by one of ordinary skill in the art, any number of networks, systems, devices, components, and the like, may be connected to the Internet 150 and thus may be reached by the SD-WAN Gateway 160. The SD-WAN Gateway 160 may also be connected to a Private Network Intranet 170 (which may be also referred to herein as a “Private Network”), which may have a multitude of hosts connected to it, including Private Network Hosts 171a, 171b, and 171c. In some implementations, any of the Public Internet Hosts 151a, 151b, or 151c, and any of the Private Network Hosts 171a, 171b, and 171c may include any type of computing or mobile device, such as, e.g., a laptop, a tablet, a mobile phone, an appliance, a camera, a sensor, a thermostat, a vehicle, a display, any sort of consumer device, and/or any other network-enabled computing device, element, or system. It should be appreciated that a network of such devices may be commonly referred to as the “Internet of Things” (IoT).

The Private Network 170 (which may form an intranet, and thus also be referred to as “the Private Network Intranet 170”) may be, for example, a corporate enterprise network and/or part of a Virtual Private Network (VPN). In some implementations, one of remote LAN Hosts 101a, 101b, and 101c, and/or one of the Public Internet Hosts 151a, 151b, or 151c, may form a VPN connection over the SD-WAN with a server and/or one of the Private Network Hosts 171a, 171b, and 171c in the Private Network 170. For example, a home worker may employ one of the remote LAN Hosts 101a, 101b, and 101c to connect with the corporate e-mail server on the Private Network 170.

In the multi-network SD-WAN communication system of FIG. 1A, any of the Remote LAN Hosts 101a, 101b, and/or 101c may communicate with any of the Public Internet Hosts 151a, 151b, and/or 151c and/or any of the Private Network Hosts 171a, 171b, and/or 171c. Any such communication involves transmitting data over two different network transports, a first network transport (i.e., over the HTS network 130 and the Internet 150) accessed using the HTS Modem 123, which may hereinafter be referred to as “the HTS tunnel” as indicated by the two-headed arrow 131 in FIG. 1A, and a second network transport (i.e., over the LTE network 140 and the Internet 150) accessed using the LTE modem 124, which may hereinafter be referred to as “the LTE tunnel” as indicated by the two-headed arrow 141 in FIG. 1A.

As discussed in further detail below, the SD-WAN Router 110 and the SD-WAN Gateway 160 may manage the two transports such that the use of two concurrent connections may be transparent to the Remote LAN Host 101 and whichever host with which it may be communicating. Generally speaking, when any of the Remote LAN Hosts 101a, 101b, and/or 101c sends data packets to transmit, the SD-WAN Router 110 evaluates the packets and network conditions to determine which network transport to use (e.g., the HTS tunnel 131 or the LTE tunnel 141) for each packet or group of packets. For example, the SD-WAN Router 110 may classify packets to specify the classes of service (e.g., levels of latency) needed for each packet, and then select the most appropriate of the available network transports given the class of service. The SD-WAN Router 110 then sends each packet to the SD-WAN Gateway 160 using the selected network transport for the packet, and the SD-WAN Gateway 160 sends the packets on to the appropriate network hosts, e.g., any one or more of the Public Internet Hosts 151a, 151b, and/or 151c (hereinafter, “Public Internet Host(s) 151”) or any of the Private Network Hosts 171a, 171b, and/or 171c. A similar, complementary process is used to transmit data on the return direction from the SD-WAN Gateway 160 to the SD-WAN Router 110 and back to any of the Remote LAN Hosts 101a, 101b, and/or 101c (hereinafter, “Remote LAN Host(s) 101”). As a result of this technique, the SD-WAN Router 110 and SD-WAN Gateway 160 may make use of the concurrently available network transports to achieve the advantages of each.

While the example in FIG. 1A and other implementations herein may include two specific network transports, e.g., HTS and LTE, other physical access technologies or network transports may also be included, e.g., coaxial cable, fiber optic cable, digital subscriber line (DSL), various types of cellular telecommunication technologies, and the like, as would be understood by one of ordinary skill in the art. Moreover, more than two network transports, multiple instances of the same type of network transport, and/or any combination of these and/or other network transports may be used in accordance with the present subject matter, for example, to provide load balancing among a multitude of various network transports between the SD-Wan Router 110 and the SD-WAN Gateway 160. connections.

As shown in FIG. 1A, network tunneling is employed to connect the SD-WAN Router 110 and the SD-WAN Gateway 160, e.g., the HTS Tunnel 131 is employed for packets exchanged over the HTS transport network and the LTE Tunnel 141 is employed for packets exchanged over the LTE transport network. When privacy is required, or when a VPN may be employed, or any of the Private Network Hosts 171a, 171b, and/or 171c (hereinafter “Private Network Host(s) 171”) may be communicating over the WAN transports, the Internet Protocol Security (IPSec) suite of protocols may be employed for the end-to-end encryption of packets over the HTS Tunnel 131 and/or the LTE Tunnel 141. When privacy is not required, Generic Routing Encapsulation (GRE) may be employed, which allows routing protocols such as Routing Information Protocol (RIP) and Open Shortest Path First (OSPF) to be used for transmitting packets over the HTS Tunnel 131 and/or the LTE Tunnel 141. In some implementations, other tunneling mechanisms and/or networking protocols/techniques may be employed for relaying packets between the SD-WAN Router 110 and the SD-WAN Gateway 160.

The HTS Tunnel 131 and the LTE Tunnel 141 may connect via the Internet interface to the SD-WAN Gateway 160, which may flexibly forward packets to and from the Remote LAN host(s) 101 over the HTS Tunnel 124 and LTE Tunnel 134 via the SD-WAN Router 110. By a separate connection (i.e., not over the Internet 150), the SD-WAN Gateway 160 may flexibly forward packets to and from the Private Network Intranet 170 and its Private Network Host(s) 171, and then appropriately forward and return them over the Internet 150, the HTS Tunnel 131, and/or the LTE Tunnel 141, using suitable privacy protocols. Similarly, the SD-WAN Gateway 150 may forward packets to and from the Public Internet 150 and its Public Internet Host(s) 151 (optionally by performing a Network Address Translation (NAT) function).

The SD-WAN Router 110 and SD-WAN Gateway 160 together implement SD-WAN policies that provide for identifying and classifying IP flows and then selecting which tunnel (the HTS Tunnel 131 or the LTE Tunnel 141) should carry the IP flow based on, among other factors, the applicable policies, the IP flow's classification, and the measured performance of the WAN transports (i.e., the HTS Tunnel 131 and the LTE Tunnel 141). The two WAN transports, the HTS Tunnel 131 and the LTE Tunnel 141, may concurrently support transfers for many different connections, including for connections between different LAN hosts.

Generally speaking, the SD-WAN Router 110 and the SD-WAN Gateway 160 may classify and assign communication traffic between hosts to different tunnels or WAN transports at different levels of granularity. In some implementations, communication traffic may be assigned to different tunnels or WAN transports according to a connection as a whole, on an IP flow basis (e.g., for each individual IP flow with a connection being assigned separately), for groups of packets, or for individual packets, as would be understood by one of ordinary skill in the art. In some implementations, the assignment of traffic may be periodically re-evaluated, such as, e.g., after a predetermined period of time, or after the predetermined amount of data is received/transmitted. In some implementations, the SD-WAN Router 110 and the SD-WAN Gateway 160 may evaluate communication data on an individual packet-by-packet basis or as a group of packets. Accordingly, as incoming packets of a connection are received, each individual packet or group of packets may be newly evaluated in light of current network conditions (including the queue depths of the HTS Tunnel 131 and the LTE Tunnel 141) and may be assigned to achieve the best overall performance, e.g., lowest latency, lowest cost, and/or other metrics, which can vary based on the class of service indicated by the classification of the packets.

### The SD-WAN Router and the SD-WAN Gateway

FIG. 1A also illustrates some of the internal components of the SD-WAN Router 110 and the SD-WAN Gateway 160, according to which examples may be applied. The components illustrated in the SD-WAN Router 110 and the SD-WAN Gateway 160 in FIG. 1A are provided for purposes of illustrating aspects, features, characteristics, and/or components relevant and/or germane to examples and/or implementations of the present disclosure, and thus, it should be appreciated that FIG. 1A may omit aspects, features, characteristics, and/or components of the SD-WAN Router 110 and the SD-WAN Gateway 160 not germane to examples and/or implementations of the present disclosure, as would be understood by one of ordinary skill in the art; moreover, some of the aspects, features, characteristics, and/or components the SD-WAN Router 110 and the SD-WAN Gateway 160 described herein may be removed from and/or modified in the SD-WAN communication system shown in FIG. 1A without departing from the scope of the present disclosure, as would also be understood by one of ordinary skill in the art.

Generally speaking, both the SD-WAN Router 110 and the SD-WAN Gateway 160 perform the same steps of, for example, receiving a packet, classifying a packet to determine a class of service, selecting one of multiple available network transports, queuing the packets according to the network transport and class of service assigned, tunneling the packets for a tunnel that corresponds to the selected network transport, and then transmitting the packet over either the HTS Tunnel 131 or the LTE Tunnel 141. Accordingly, similar components are shown performing similar operations in both the SD-WAN Router 110 and the SD-WAN Gateway 160; however, the components may be implemented substantially different according to the functions and operations of the SD-WAN Router 110 and the SD-WAN Gateway 160, especially in light of the SD-WAN Router 110's usage of two single-purpose modems (i.e., the HTS Modem 123 and the LTE Modem 124) in comparison to the SD-WAN Gateway 160's multi-purpose usage and multitude of possible implementations of communication interconnections with the Internet 150.

In FIG. 1A, the SD-WAN Router 110 and the SD-WAN Gateway 160 each include a Classifier 112 and 162; a WAN Selector 113 and 163; the HTS Un-Tunnelers 115h and 165h at each end of the HTS Tunnel 131, and the LTE Un-Tunnelers 115l and 165l at each end of the LTE Tunnel 141; Re-Sequencers 117 and 167; and various network interfaces (I/Fs), including the Remote LAN I/F 111 interfaced between the SD-Wan Router 110 and the Remote LAN Network 105, the Internet I/F 161i interfaced between the SD-Wan Gateway 160 and Internet 150, and the Private Network I/F 161p interfaced between the SD-Wan Gateway 160 and the Private Network Intranet 170. The Classifier 112 and Re-Sequencer 117 of the SD-WAN Router 110 are connected to the input from, and the output to, respectively, the Remote LAN Network 105 through the Remote LAN I/F 111. In the SD-WAN Gateway 160, an additional component Multi-Network I/O 169 acts as the communication traffic manager for the traffic flows of the various networks connected to the SD-WAN Gateway 160. Namely, the Classifier 162 and Re-Sequencer 167 of the SD-WAN Gateway 160 are connected through the Multi-Network I/O 169 to the input from, and the output to, respectively, the Internet I/F 161 and the Internet 150. Similarly, the Classifier 162 and Re-Sequencer 167 of the SD-WAN Gateway 160 are also connected through the Multi-Network I/O 169 to the input from, and the output to, respectively, to the Private Network I/F 161l and the Private Network Intranet 170.

When the SD-WAN Router 110 or SD-WAN Gateway 160 receive an outbound packet, that is, a packet to be forwarded through either the HTS Tunnel 131 or the LTE Tunnel 141, the Classifier 112/162 examines the packet and, based on the packet's content, metadata, and/or other relevant packets (especially those from the same IP flow), assigns the packet a class (or, equivalently, a class-of-service) from a predetermined set of classes. For more details concerning the sets, sub-sets, categories, priorities, and the like, of classification, please refer to U.S. Pat. No. 11,362,920 to the same assignee (hereinafter, “the '920 patent”), which is hereby incorporated by reference herein in its entirety. The Classifier 112/162 passes the classified packet to the WAN Selector 113/163 which is responsible for assigning the packet to one WAN or the other based on its classification. The WAN Selector 113/163 passes the classified packet such that the packet is appropriately transmitted via the assigned WAN. FIG. 1A is a simplified block diagram, and there may be a variety of additional components between the WAN Selector 113/163 and its assigned WAN transport or tunnel. For example, between the WAN Selector 113 in SD-WAN Router 110 and either of the HTS Modem 123 or the LTE Modem 124, there may be a queue, a rate limiter, a tunneler, and the like, as would be understood by one of ordinary skill in the art. For more details, see, e.g., the '920 patent.

When the SD-WAN Router 110 or SD-WAN Gateway 160 receive an inbound packet, that is, a packet from either the HTS Tunnel 131 or the LTE Tunnel 141 (and thus from either the HTS Modem 123 or the LTE Modem 124 for the SD-WAN Router 110), the appropriate Un-Tunneler of the HTS Un-Tunnelers 115h and 165h and the LTE Un-Tunnelers 115l and 165l performs the appropriate un-tunneling of the received packet to restore it to the form it had before the packet was tunneled for transmission over either the HTS Tunnel 131 or the LTE Tunnel 141. In the SD-WAN Router 110, the HTS Un-Tunneler 115h and the LTE Un-Tunneler 115l pass their untunneled packets to the Re-Sequencer 117; in the SD-WAN Gateway 160, the HTS Un-Tunneler 165h and the LTE Un-Tunneler 165l pass their untunneled packets to the Re-Sequencer 167. The Re-Sequencer 117/167 dynamically maintains a re-sequencing queue for each active IP flow, and allocates the untunneled packets to the appropriate IP flow re-sequencing queue. Once the packets are appropriately re-sequenced (see the '920 patent for more details), the packets may be forwarded to the appropriate network interface (I/F) and forwarded to the next hop. The SD-WAN Gateway 160, when forwarding a packet onto the Internet 150 may optionally perform a Network Address Translation (NAT) or Network Address Port Translation (NAPT) operation thereby minimizing the number of public IP addresses the SD-WAN Gateway 160 must be allocated to support a given number of SD-WAN Routers, (such as, e.g., SD-WAN Router 110).

Although only classification is directly referenced above, any number of policies, rules, priorities, requirements, and the like, may also be applied as part of the routing and processing of the packets over the multiple WAN transports. See, e.g., the '920 patent; U.S. Pat. No. 11,777,760, assigned to the same assignee (hereinafter, “the '760 patent”), which is hereby incorporated by reference herein in its entirety; and U.S. Pat. No. 10,637,782, assigned to the same assignee (hereinafter, “the '782 patent”), which is also hereby incorporated by reference herein in its entirety. These are not described in detail herein as there are believed not to be directly relevant and/or germane to the explanation of the examples and/or implementations herein.

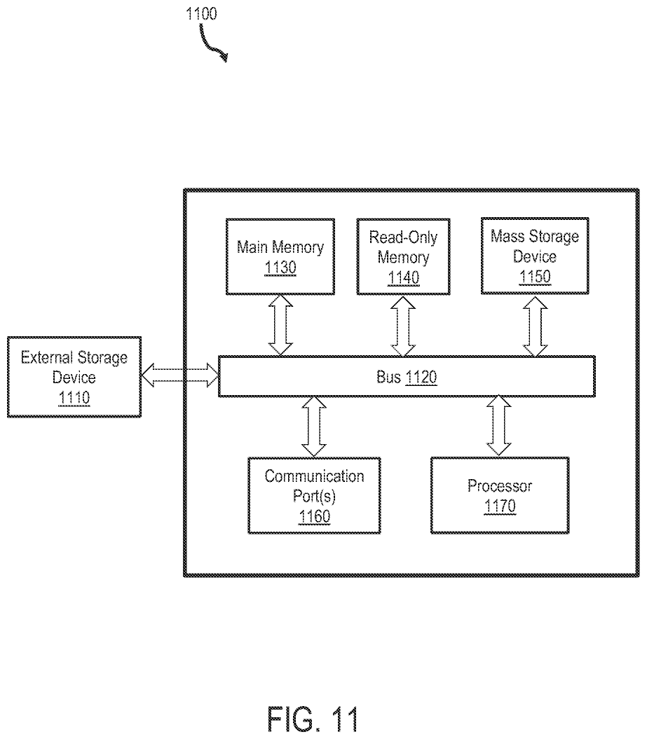

The SD-WAN Router 110 and/or SD-WAN Gateway 160 may include various components, implemented in hardware, software, or a combination thereof, to facilitate communication in accordance examples herein. In some implementations, each of the SD-WAN Router 110 and the SD-WAN Gateway 160 may include one or more processors and one or more memories to carry out operations, functions, and/or methods in accordance herewith. In some implementations, the one or more processors and one or more memories may be provided as described and shown in FIG. 11 below.

In some implementations, the SD-WAN Gateway 160 may facilitate a traffic processing function, which may allow forwarding and protocol processing between external public networks and private networks and gateway communication channels. Although depicted in FIG. 1A (and the following figures/drawings) as a single element, the SD-WAN Gateway 160, in some implementations, may be separated into numerous components in multiple locations and/or integrated, fully or partially, with other components. The SD-WAN Router 110 and/or the SD-WAN Gateway 160 may perform many other functions not directly referenced in this description and therefore omitted for clarity. Additionally, given architectures might place certain functions within the SD-WAN Router 110 and/or the SD-WAN Gateway 160 and might place certain functions or elements outside of the SD-WAN Router 110 and/or the SD-WAN Gateway 160. Such differences are not material to the design disclosed here. Furthermore, there may be implementations where the SD-WAN Router 110, the SD-WAN Gateway 160, and/or other components in FIG. 1A (and the following figures/drawings) may utilize any combination of multiple gateways, network data centers, network management systems, and the like to perform the methods as described herein. While the processors/computing devices, components, systems, subsystems, and/or other elements may be shown as single entities in FIG. 1A (and the following figures/drawings), one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the SD-WAN Router 110, the SD-WAN Gateway 160, and/or other components in FIG. 1A (and the following figures/drawings).

### WAN Transport Operational Status

FIG. 1B is a further simplified block diagram illustrating the SD-WAN communication system of FIG. 1A: the simplifications depicted in FIG. 1B are for purposes of simplifying and/or clarifying the more germane and/or relevant aspects, features, characteristics, and/or components of examples and/or implementations of the present disclosure, and thus, it should be appreciated that FIG. 1B omits aspects, features, characteristics, and/or components not germane to examples and/or implementations of the present disclosure, as would be understood by one of ordinary skill in the art.

As shown in FIG. 1B, most of the internal components in both the SD-WAN Router 110 and the SD-Wan Gateway 160 have been replaced by a simple triangular shape, which is meant to represent the entire routing, classifying, and the like, process as performed by the SD-WAN Router 110 and the SD-Wan Gateway 160. Accordingly, the communication traffic from the Remote LAN Network 105 enters through Remote LAN I/F 111 and is appropriately routed via one of the WAN transports, i.e., either the HTS Tunnel 131 or the LTE Tunnel 141, by the SD-WAN Router 110 (as indicated by the triangular shape in the SD-WAN Router 110). Similarly, the communication traffic from either the Internet 150 or the Private Network Internet 170 enters through Internet I/F 161i and/or Private Network I/F 161p, respectively, and is appropriately routed via one of the WAN transports, i.e., either the HTS Tunnel 131 or the LTE Tunnel 141, by the SD-WAN Gateway 160 (as indicated by the triangular shape in the SD-WAN Gateway 160).

FIG. 1B is used herein to describe the operational connectivity status of each of the WAN transports, i.e., the HTS Tunnel 131 and the LTE Tunnel 141, as one of CLEAN, BROWNOUT, or BLACKOUT. In some implementations, a WAN transport may have: (i) a CLEAN status when it is operating such that the operational connectivity is sufficient for the requisite level of transport availability for the communications data flow; (ii) a BLACKOUT status when it is experiencing a complete outage; and (iii) a BROWNOUT status when it is operating such that the operational connectivity is insufficient for the requisite level of transport availability for the communications data flow. For more details concerning CLEAN, BLACKOUT, and BROWNOUT status, see, e.g., the '782 patent and U.S. Pat. No. 10,178,035, assigned to the same assignee (hereinafter, “the '035 patent”), which is also hereby incorporated by reference herein in its entirety.

Some of the factors for determining the operational status of a WAN transport are listed below, in general terms:
Connectivity—whether the WAN transport is capable of carrying packets.
Estimated Capacity—how many bits per second of communication traffic the WAN transport is estimated to be able to carry.
Packet Loss—what fraction of packets transmitted over the WAN transport may be lost per connection, and/or IP flow.
Latency—the delay between transmission and reception of packets.
Jitter—the variation in the delay between transmission and reception of packets.
Cost—the relative cost in terms of price per GB (which may be made available to an SD-WAN router and/or SD-WAN gateway in the form of configuration settings).
Reliability—the estimated reliability of the WAN transport (for example, a T1 line is expected to be much more reliable than another WAN transport, such as LTE).

FIGS. 1C and 1D use the further simplified block diagram of FIG. 1B to illustrate how a WAN transport may be affected by its operational status. More specifically, FIG. 1C illustrates a connection 191 from the Remote LAN Host(s) 101 to the Public Internet Host(s) 151 using the LTE Tunnel 141, while FIG. 1D illustrates a connection 193 from the Remote LAN Host(s) 101 to the Private Network Host(s) 171 using the HTS Tunnel 131.

While the connection 191 in FIG. 1C is over the LTE Tunnel 141 and the connection 193 in FIG. 1D is over the HTS Tunnel 131, this is not because of the nature of any of the end hosts, i.e., Remote LAN Host(s) 101, Public Internet Host(s) 151, and/or Private Network Host(s) 171, but instead determined by, among other things, the operational status of the WAN Transports. In other words, because the LTE Tunnel 141 was determined to be more appropriate than the HTS Tunnel 131 in FIG. 1C (because, for example, the HTS Tunnel 131 was in BROWNOUT), the LTE Tunnel 141 was used to carry all of the packet traffic between the Remote LAN Host(s) 101 and the Public Internet Host(s) 151 involved with communication connection 191. Similarly, because the HTS Tunnel 131 was determined to be more appropriate than the LTE Tunnel 141 in FIG. 1D (because, for example, the LTE Tunnel 141 was in BLACKOUT), the HTS Tunnel 131 was used to carry all of the packet traffic between the Remote LAN Host(s) 101 and the Private Network Host(s) 171 involved with communication connection 193.

However, experience has shown there may be considerable differences between the operational status and overall health of the upstream traffic flow and the downstream traffic flow of one WAN transport. Accordingly, for example, in a scenario where the upstream direction of an LTE transport may have a low capacity (i.e., in BROWNOUT) while the downstream direction of the LTE transport has a relatively decent capacity (i.e., at least CLEAN), the entire LTE transport may be considered BROWNOUT and hence an alternate WAN transport, such as, e.g., an HTS transport, which is CLEAN, may end up carrying all end-user traffic in both the upstream and downstream directions. However, the LTE transport may have provided better performance in the downstream direction for certain types of end user connections (such as, e.g., latency sensitive applications). Thus, the use of the entire WAN transport for both the upstream and the downstream may actually reduce performance in at least one of the traffic directions.

As another example, if the operational status of the downstream traffic flow of the HTS Tunnel 131 is extremely bad, the HTS Tunnel 131 may not be assigned a connection, even though the operational status of its upstream traffic is very good, thereby degrading overall system efficiency in some cases because the operational status and condition of the upstream traffic of the selected WAN transport (in this case, the LTE Tunnel 141) may actually be considerably worse than the operational status and condition of the upstream traffic of the non-selected WAN transport (in this case, the HTS Tunnel 131). As these examples demonstrate, the classification of entire WAN transports may, under certain circumstances, degrade overall system efficiency.

### Directional SD-WAN Operational Status Classification-System(s)

According to various examples and/or implementations in accordance herewith, the upstream and downstream of a WAN transport may be classified separately rather than classifying the entire WAN transport (i.e., both the upstream and the downstream) based on its average and/or overall status/health. As used herein, “upstream” may refer to the traffic flow in the direction from an SD-WAN Router to an SD-WAN Gateway, and “downstream” may refer to the traffic flow in the direction from an SD-WAN Gateway to an SD-WAN Router.

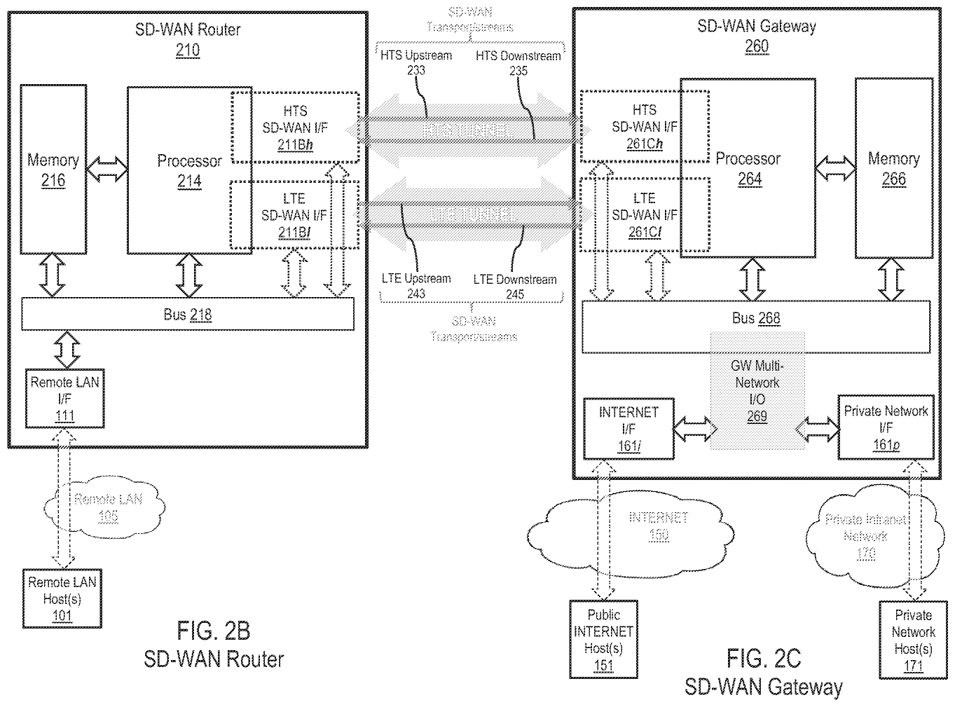

FIG. 2A is a block diagram illustrating an SD-WAN communication system having directional WAN transport/stream classification, according to examples. Many components in FIG. 2A are similar in nature and function to the components in FIGS. 1A-1D and are thus identified by the same reference numerals. The SD-WAN communication system depicted in FIG. 2A is provided for purposes of illustrating aspects, features, characteristics, and/or components relevant and/or germane to examples and/or implementations of the present disclosure, and thus, it should be appreciated that FIG. 2A may omit aspects, features, characteristics, and/or components not germane to examples and/or implementations of the present disclosure, as would be understood by one of ordinary skill in the art; moreover, some of the aspects, features, characteristics, and/or components described herein may be removed from and/or modified in the SD-WAN communication system shown in FIG. 2A without departing from the scope of the examples and/or implementations of the present disclosure, as would also be understood by one of ordinary skill in the art.

FIG. 2A includes an SD-WAN Router 210 and an SD-WAN Gateway 260, and similarly to FIGS. 1A-1D, the SD-WAN Router 210 has its Remote LAN I/F 111 and its connected HTS Modem 123 and LTE Modem 124; the HTS Network 130; the LTE Network 140; the Internet 150 connected to Public Internet Host(s) 151; and the SD-WAN Gateway 260 directly connected to the Internet 150 and having its own Multi-Network I/O 269, Internet I/F 161i, and Private Network I/F 161p; the Private Network Intranet 170 connected to Private Network Host(s) 171; and the Remote LAN Network 105 connected to Remote LAN Host(s) 101.

By contrast with FIGS. 1A-1D, FIG. 2A illustrates the two directional streams in each of the WAN transports: namely, the HTS Upstream 233 and the HTS Downstream 235 in the HTS Tunnel 231, and the LTE Upstream 243 and the LTE Downstream 245 in the LTE Tunnel 241. In implementations in accordance herewith, each of the HTS Upstream 233, the HTS Downstream 235, the LTE Upstream 243, and the LTE Downstream 245 may have their own separate and distinct operational status separate from their tunnels. In other words, in implementations in accordance herewith, the upstream and the downstream of each WAN transport has its own operational status, and thus the upstream and the downstream of any IP flow may be provisioned separately, thereby increasing efficiency. Specifically, in some examples, the selection of the WAN transport to carry packets of an upstream or a downstream IP flow may be made based on the status of the streams in the WAN transports in the corresponding direction along with other performance metrics of the WAN transports, such as for example, capacity, packet loss, latency, jitter, etc., as would be understood by one of ordinary skill in the art.

Because the downstream and the upstream of the WAN transport are considered separately according to implementations in accordance herewith, each of these individual streams may be referred to hereinafter generically as a “WAN transport/stream” rather than merely a “WAN transport.” For instance, while the HTS Tunnel 231 in FIG. 2A may be a WAN transport, each of the HTS Upstream 233 and the HTS Downstream 235 may be an individual WAN transport/stream separate and distinct from an entire WAN transport. Similarly, while the LTE Tunnel 241 in FIG. 2A may be a WAN transport, each of the LTE Upstream 243 and the LTE Downstream 245 may be an individual WAN transport/stream separate and distinct from an entire WAN transport. Accordingly, the terms “WAN Transport/stream,” “SD-WAN Transport/stream,” “a directional WAN Transport/stream,” and/or “a directional SD-WAN Transport/stream” may be used herein interchangeably (depending on context) to refer to a unidirectional (i.e., one-way-either upstream or downstream) stream in an SD-WAN tunnel and/or SD-WAN transport (which are themselves carried over a WAN transport).

The SD-WAN Router 210 and/or the SD-WAN Gateway 260 in FIG. 2A may include various components, implemented in hardware, software, or a combination thereof, to facilitate both the operations and functions described herein, in accordance with examples and/or implementations in accordance herewith. In some implementations, each of the SD-WAN Router 210 and the SD-WAN Gateway 260 may include one or more processors and one or memories to carry out operations and/or methods in accordance herewith. In some implementations, such one or more processors and one or memories may be provided as described and shown in FIGS. 2B and 2C below, and/or FIG. 11 further below.

FIG. 2B is a block diagram illustrating the SD-WAN Router 210, such as that shown in FIG. 2A, capable of routing unidirectional IP flows on individual directional SD-WAN transport/streams over WAN transports, according to examples and/or implementations, while FIG. 2C is a block diagram illustrating the SD-WAN Gateway 260, such as that shown in FIG. 2A, also capable of routing unidirectional IP flows on individual directional SD-WAN transport/streams over WAN transports, according to examples and/or implementations. Many components in FIGS. 2B and 2C are similar in nature and function to the components in FIG. 2A and are thus identified by the same reference numerals. The SD-WAN Router 210 and the SD-WAN Gateway 260 depicted in FIGS. 2B and 20, respectively, are provided for purposes of illustrating aspects, features, characteristics, and/or components relevant and/or germane to examples and/or implementations of the present disclosure, and thus, it should be appreciated that FIGS. 2B and 2C may omit aspects, features, characteristics, and/or components not germane to examples and/or implementations of the present disclosure, as would be understood by one of ordinary skill in the art; moreover, some of the aspects, features, characteristics, and/or components described herein may be removed from and/or modified in the SD-WAN Router 210 and the SD-WAN Gateway 260 depicted in FIGS. 2B and 2C, respectively, without departing from the scope of the examples and/or implementations of the present disclosure, as would also be understood by one of ordinary skill in the art.

FIGS. 2B and 2C include, similar to FIG. 2A, the SD-WAN Router 210 having its Remote LAN I/F 111 communicatively connecting to Remote LAN Host(s) 101 through the Remote LAN Network 105 and the SD-WAN Gateway 260 having its Multi-Network I/O 269, the Internet I/F 161i communicatively connecting to Public Internet Host(s) 151 through the Internet 150, and Private Network I/F 161p communicatively connecting to Private Network Host(s) 171 through the Private Intranet Network 170,

The SD-WAN Router 210 in FIG. 2B may also include a processor 214 and a memory 216 communicatively coupled to the processor 214, as well as a bus 218 communicatively connecting components of the SD-WAN Router 210. The memory 216 may be a standard computer-readable medium for storage and/or retrieval of information, and may be used, for example, to store and provide access to information pertaining to various operations of and in the SD-Wan Router 210. The memory 216 may include processor-executable instructions, which on execution, cause the processor 214 of the SD-WAN Router 210 to perform one or more methods, operations, and/or functions described herein. Similarly, the SD-WAN Gateway 260 in FIG. 2C may also include a processor 264 and a memory 266 communicatively coupled to the processor 264, as well as a bus 268 communicatively connecting components of the SD-WAN Gateway 260. The memory 266 may be a standard computer-readable medium for storage and/or retrieval of information, and may be used, for example, to store and provide access to information pertaining to various operations of and in the SD-WAN Gateway 260. The memory 266 may include processor-executable instructions, which on execution, cause the processor 264 of the SD-WAN Gateway 260 to perform one or more methods, operations, and/or functions described herein. Either or both of an SD-WAN router and/or SD-WAN gateway according to examples and/or implementations in accordance herewith may take other forms, as would be understood by one of ordinary skill in the art, such as, for example, the Computer System 1100 in FIG. 11.

The SD-WAN transport/streams in the SD-WAN tunnels between the SD-WAN Router 210 and the SD-WAN Gateway 260 are also shown in FIGS. 2B and 2C. Namely, the HTS Upstream 233 and the HTS Downstream 235 of the HTS Tunnel, and the LTE Upstream 243 and the LTE Downstream 245 of the LTE Tunnel—each of which may have their own separate and distinct operational status separate from their tunnels. As described herein, in examples and/or implementations in accordance herewith, the upstream and the downstream (i.e., the individual WAN transport/streams) of each SD-WAN tunnel in any WAN transport has its own operational status, and thus the upstream and the downstream of any SD-WAN communication connection may be provisioned separately, thereby increasing efficiency.

As shown in FIGS. 2B and 2C, each of the SD-WAN Router 210 and the SD-WAN Gateway 260 may have interfaces (I/Fs) with each SD-WAN tunnel. Because these interfaces, much like the SD-WAN tunnels themselves, are the products of software, firmware, and/or hardware in varying combinations, the SD-WAN interfaces (I/Fs) are shown in FIGS. 2B and 2C as dotted line boxes extending into the processors of each SD-WAN device, and connecting the SD-WAN tunnels between the two SD-WAN devices. More specifically, the SD-WAN Router 210 may have an HTS SD-WAN I/F 211Bh and an LTE SD-WAN I/F 211Bl, whereas the SD-WAN Gateway 260 may have an HTS SD-WAN I/F 261Ch and an LTE SD-WAN I/F 261Cl. As would be understood by one of ordinary skill in the art, the tunnels and I/Fs in shown between the SD-WAN Router 210 and the SD-WAN Gateway 260 in FIGS. 2B-2C are intended to represent the large variety of possible physical implementations, as discussed below.

As mentioned in the previous paragraph, the HTS SD-WAN I/F 211Bh of the SD-WAN Router 210 in FIG. 2B, the HTS SD-WAN I/F 261Ch of the SD-Wan Gateway 260 in FIG. 2C, and the HTS Tunnel formed between them in FIGS. 2B-2C, are intended to be interpreted in their most possible broadest functional sense, and may be implemented by any combination of software and/or hardware (including firmware). Accordingly, the specific configuration shown in FIG. 2A, where the HTS Tunnel is implemented by an HTS Modem 123 connecting the SD-WAN Router 210 to/through the HTS network 130 and, in turn, to/through the Internet 150, to the SD-WAN Gateway 260, is one of the many possible implementations of the HTS Tunnel in FIGS. 2B-2C. Similarly, the LTE SD-WAN I/F 211B/of the SD-WAN Router 210 in FIG. 2B, the LTE SD-WAN I/F 261Cl of the SD-WAN Gateway 260 in FIG. 2C, and the LTE Tunnel formed between them in FIGS. 2B-2C, are intended to be interpreted in their most possible broadest functional sense, and may be implemented by any combination of software and/or hardware (including firmware). Accordingly, the specific configuration shown in FIG. 2A, where the LTE Tunnel is implemented by an LTE Modem 124 connecting the SD-WAN Router 210 to/through the LTE network 140 and, in turn, to/through the Internet 150, to the SD-WAN Gateway 260, is one of the many possible implementations of the LTE Tunnel in FIGS. 2B-2C. Furthermore, for example, the HTS SD-WAN I/F 261Ch and the LTE SD-WAN I/F 261Cl of the SD-WAN Gateway 260 in FIG. 2C may take any form of hardware, software, or combination of the two, including, but not limited to, a single dedicated hardware interface with the Internet 150, such as shown in the configuration of FIG. 2A.

As shown in FIGS. 2B and 20, the HTS SD-WAN I/F 211Bh and the HTS SD-WAN I/F 261Ch communicatively connect the SD-WAN Router 210 and the SD-WAN Gateway 260 via the HTS Tunnel, which includes at least two SD-WAN transport/streams, i.e., the HTS Upstream 233 and the HTS Downstream 235. Similarly, the LTE SD-WAN I/F 211BI and the LTE SD-WAN I/F 261CI communicatively connect the SD-WAN Router 210 and the SD-WAN Gateway 260 via the LTE Tunnel, which includes at least two SD-WAN transport/streams, i.e., the LTE Upstream 243 and the LTE Downstream 245. The HTS SD-WAN I/F 211Bh of the SD-WAN Router 210 handles both transmitting and receiving SD-WAN packet traffic over the HTS Upstream 233 and the HTS Downstream 235, respectively, whereas the LTE SD-WAN I/F 211BI of the SD-WAN Router 210 handles both transmitting and receiving SD-WAN packet traffic over the LTE Upstream 243 and the LTE Downstream 245, respectively. Similarly, the HTS SD-WAN I/F 261Ch and the LTE SD-WAN I/F 261CI of the SD-WAN Gateway 260 handle the SD-WAN packet traffic over their respective tunnels/WAN transports.

Accordingly, the use of separate WAN transports, separate individual SD-WAN transport/streams, different communication networks, both a satellite system and a terrestrial cellular system, and the like, is completely transparent to the transmitting and receiving end hosts of the communication connection—in other words, for example, the end users of the communication have no idea how the packets constituting their conversation may be split and transmitted by both, e.g., a satellite and a cellular telephone network.

In some implementations, the processor 214 of the SD-WAN Router 210 in FIG. 2B and/or the processor 264 of the SD-WAN Gateway 260 in FIG. 2C may be, or may include, one or more programmable general-purpose or special-purpose single- and/or multi-chip processors, a single- and/or multi-core processors, microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices. In some implementations, the memory 216 of the SD-WAN Router 210 in FIG. 2B and/or the memory 266 of the SD-WAN Gateway 260 in FIG. 2C may include read-only memory (ROM), flash memory, and/or random access memory (RAM)—any of which may be the main memory into which an operating system, various application programs, and/or a Basic Input-Output system (BIOS) which controls basic hardware operation such as the interaction with one or more peripheral components may be loaded/stored. Code or computer-readable instructions to implement the methods, functions, and/or operations discussed and/or described herein may be stored in computer-readable storage media such as the memory 216 of the SD-WAN Router 210 in FIG. 2B, the memory 266 of the SD-WAN Gateway 260 in FIG. 2C, any of the storage media 1110, 1130, 1140, and 1150 in FIG. 11, or other suitable storage. Code or computer-readable instructions to implement the methods, functions, and/or operations discussed and/or described herein may also be received via one or more interfaces and/or stored in other memory. An operating system may be provided on, and/or be retrievable by, the processor 214 of the SD-WAN Router 210 in FIG. 2B and/or the processor 264 of the SD-WAN Gateway 260 in FIG. 2C, including, e.g., MS-DOS®, MS-WINDOWS®, OS/2®, OS X®, IOS®, ANDROID®, UNIX®, Linux®, or another operating system, as would be understood by one of ordinary skill in the art.

In some implementations, the processor 214 of the SD-WAN Router 210 in FIG. 2B and/or the processor 264 of the SD-WAN Gateway 260 in FIG. 2C may include one or more single- and/or multi-chip processors, one or more single- and/or multi-core processors, and/or any combination of single/multi-chip and/or single/multi-core processors. Moreover, in some examples and/or implementations, the processor 214 of the SD-WAN Router 210 in FIG. 2B and/or the processor 264 of the SD-WAN Gateway 260 in FIG. 2C may not physically interact with each packet, but may rather also include hardware that, once an IP flow has been identified and a policy set for it, applies that policy to the following packets in the identified IP flow without the processor 214 and/or the processor 264 being specifically involved.

As mentioned above, the bus 218 of the SD-WAN Router 210 in FIG. 2B and the bus 268 of the SD-Wan Gateway 260 in FIG. 2C communicatively couples the processors 214 and 216, respectively, with the other memory, storage, and communication blocks. The bus 218 and/or the bus 268 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which may connect the processors 214/265 to their respective device systems. Optionally, operator and administrative interfaces, e.g., a display, keyboard, and a cursor control device, may also be coupled to bus 218 and/or the bus 268 to support direct operator interaction with the SD-WAN Router 210 and/or the SD-WAN Gateway 260, respectively. As would be understood by one of ordinary skill in the art, the systems for the SD-WAN Router 210 and the SD-WAN Gateway 260 are shown in FIGS. 2B and 2C for purposes of explanation and illustration, and do not limit the scope of the presently discussed and/or described subject matter in any way.

### Directional SD-WAN Operational Status Classification—Method(s)

According to examples and/or implementations herein, the characteristics of the upstream and downstream of each WAN transport may be used to separately define the operational status of the upstream and downstream of each WAN transport according to different criteria. In some implementations, a set of WAN transport characteristics (like those listed above, i.e., connectivity, estimated capacity, packet loss, latency, jitter, cost, and reliability) may be established separately and distinctly for the upstream and downstream of each WAN transport. In some implementations, different sets of upstream and downstream WAN transport characteristics may be established for different groups of applications (such as, e.g., streaming video, video conferencing, web browsing, domain name lookups, gaming downloads, streaming active gaming, and the like). Each set of WAN transport characteristics may indicate the operational status for either the downstream or upstream of a WAN transport as being one of:
CLEAN—either the downstream or the upstream of the WAN transport is operating well enough to support the application.
BROWNOUT—either the downstream or the upstream of the WAN transport is impaired and is still able to carry traffic, but should only be used if no other downstream/upstream is available.
BLACKOUT—either the downstream or the upstream of the WAN transport is so impaired that no attempt should be made to use it even if no other downstream/upstream is available.

As mentioned above, because the downstream and the upstream of an SD-WAN transport are considered separately according to examples and/or implementations herein, each of these individual streams may be referred to hereinafter generically as an “SD-WAN transport/stream” rather than an “SD-WAN transport,” which may refer to the entire tunnel, i.e., all streams going in all directions. Accordingly, the terms “WAN Transport/stream,” “SD-WAN Transport/stream,” “a directional WAN Transport/stream,” and/or “a directional SD-WAN Transport/stream” may be used herein interchangeably (depending on context) to refer to a unidirectional (i.e., one-way-either upstream or downstream) stream in an SD-WAN tunnel and/or SD-WAN transport (which are themselves carried over a WAN transport). For instance, each of the HTS Upstream 233 and the HTS Downstream 235 in FIGS. 2A-2C may be referred to as an individual WAN transport/stream separate and distinct from an entire WAN transport (or from an SD-WAN tunnel such as, e.g., the HTS Tunnel 231 in FIG. 2A). Similarly, each of the LTE Upstream 243 and the LTE Downstream 245 in FIGS. 2A-2C may be referred to as an individual WAN transport/stream separate and distinct from an entire WAN transport (or from an SD-WAN tunnel such as, e.g., the LTE Tunnel 241 in FIG. 2A).

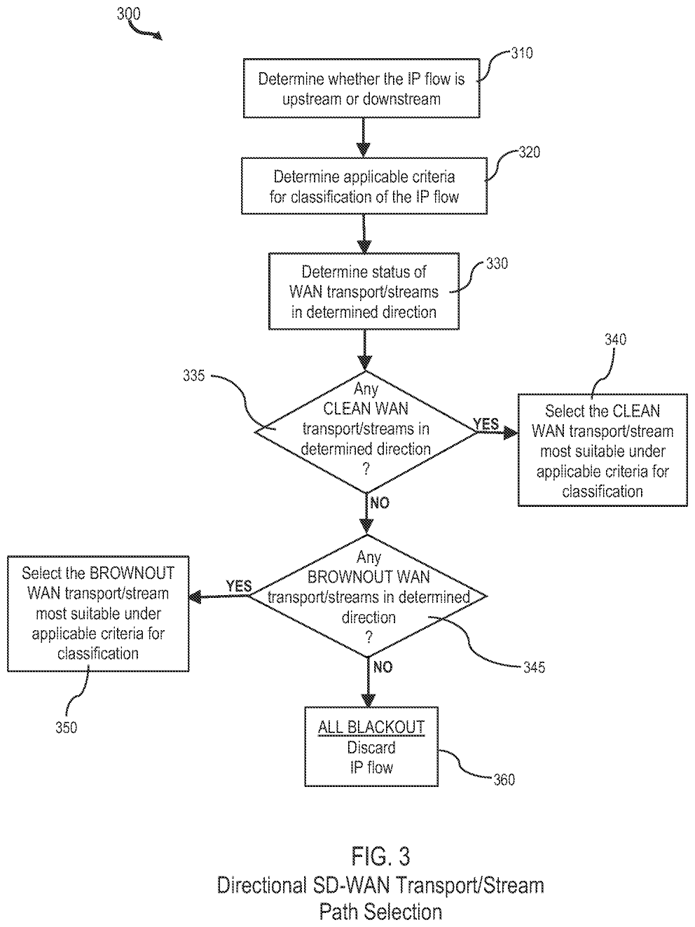

FIG. 3 illustrates a flow diagram of a method 300 of directional SD-WAN transport/stream path selection for the packets of an IP flow, according to an example. The method 300 shown in FIG. 3 is provided by way of example and may only be one part of an entire process/procedure. The method 300 may further omit parts of the method not germane to the present disclosure, as would be understood by one of ordinary skill in the art. Each block shown in FIG. 3 may further represent one or more steps, processes, methods, or subroutines, as would be understood by one of ordinary skill in the art. For the sake of convenience and ease of explanation, the blocks in FIG. 3 may refer to the components and/or descriptions of some of the other figures described herein; however, the method 300 is not limited in any way to the components, apparatuses, and/or constructions shown in any of the figures described herein. It may be appreciated by one of ordinary skill in the art that, in various implementations in accordance with the present disclosure, any of the blocks in FIG. 3 may occur in a different order and/or simultaneously (e.g., in parallel and/or concurrently), may not be performed, and/or may be performed multiple times.

In other implementations, the method 300 may be applied at different levels of granularity, as would be understood by one of ordinary skill in the art. In some implementations, the method 300 may be applied to a connection as a whole (and each IP flow therein), to groups of packets, or even to individual packets.

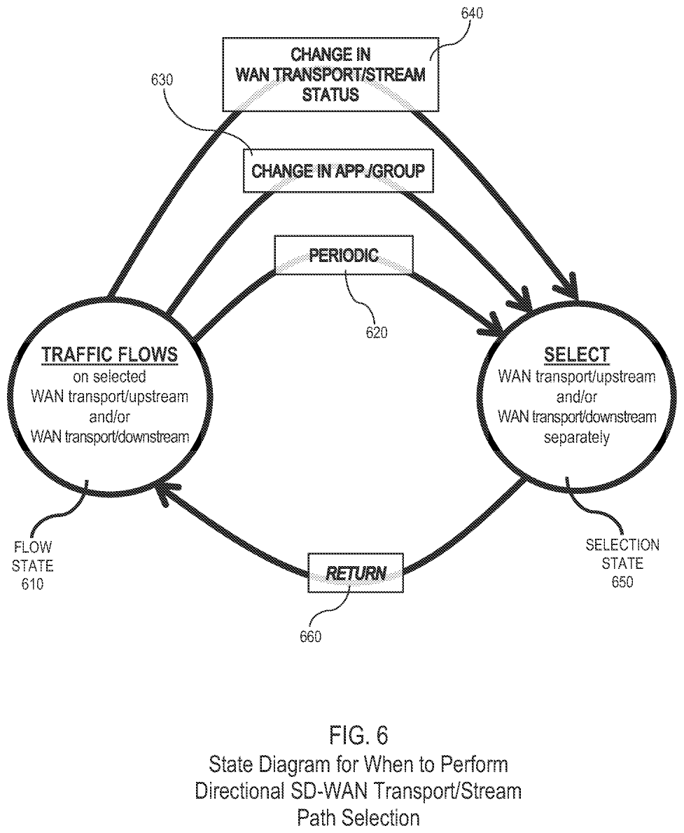

In some implementations, the method 300 of path selection may be performed at different times, under different conditions, and/or for different purposes. In some implementations, such as shown in the state diagram of FIG. 6 below, the method 300 of path selection may be performed when there is a change in the communication system (such as a change in, e.g., operational status of a WAN transport or a WAN transport/stream), a change in the communication traffic, and/or after an elapsed time period (i.e., path selection may be automatically performed periodically).

At block 310, the method 300 may determine whether the IP flow is upstream or downstream. In some implementations, there may be packet traffic from, using FIG. 2A as an illustrative example, a Remote LAN Host 101 through an SD-WAN Router 210, one or more SD-WAN connections, and an SD-WAN Router 160 to a Public Internet Host 151. In this instance, the IP flow may be upstream, e.g., through the SD-WAN transports from the SD-WAN Router 210 to the SD-Wan Gateway 260.

At block 320, the method 300 may determine the applicable criteria for classification of the IP flow. As noted above, the term “criteria” as used herein may refer to either or both the singular (“criterion”) and the plural, similarly to how the terms “agenda” and “data” are also used commonly, concisely, and clearly for both the singular and the plural in English usage. In some implementations, the applicable criteria for classification may depend upon the type of traffic, the best overall performance, e.g., lowest latency, lowest cost, or other metric, which may vary based on the class of service. For instance, the '920 patent, the '782 patent, and the '760 patent may be referred to for more in-depth discussions of classification criteria and metrics. In some implementations, the applicable criteria for classification may depend upon the application group of the IP flow. In some implementations, the applications may be grouped into two very broad categories: interactive, which may prioritize lower latency as a communication characteristic, and bulk transfer, which may prioritize lower cost as a communication characteristic.

At block 330, the method 300 may use the determined applicable classification criteria from block 320 to determine the present status of WAN transport/streams in the direction determined in block 310. In some implementations, the present status may be one of CLEAN, BROWNOUT, or BLACKOUT. In some implementations, there may be one or more HTS tunnels (such as, e.g., HTS Tunnel 231), each with an upstream WAN transport/stream (such as, e.g., HTS Upstream 233) and a downstream WAN transport/stream (such as, e.g., HTS Downstream 235), and one or more LTE tunnels (such as, e.g., LTE Tunnel 241), each with an upstream WAN transport/stream (such as, e.g., LTE Upstream 243) and a downstream WAN transport/stream (such as, e.g., LTE Downstream 245). In implementations where the determined direction in block 310 is upstream, the set of WAN transport/streams may be, using FIG. 2A as an illustrative example, HTS Upstream 233 and LTE Upstream 243, and block 330 may classify each of HTS Upstream 233 and LTE Upstream 243 as CLEAN, BROWNOUT, and BLACKOUT. In some implementations, whether the IP flow was interactive or bulk transfer would determine the set of communication characteristics (from block 330) to be applied to classify each WAN transport/stream as one of CLEAN, BROWNOUT, and BLACKOUT.

At block 335, the method 300 may determine whether any of the WAN transport/streams in the direction determined in block 310 was classified as CLEAN in block 330. If the method 300 determines there are CLEAN WAN transport/streams in block 335, the method 300 continues at block 340 to select the CLEAN WAN transport/stream which is most suitable according to the applicable criteria for the classification of the IP flow.

If the method 300 determines there are no CLEAN WAN transport/streams in block 335, the method 300 at block 345 may determine whether any of the WAN transport/streams in the direction determined in block 310 was classified as BROWNOUT in block 330. If the method 300 determines there are BROWNOUT WAN transport/streams in block 345, the method 300 continues at block 350 to select the BROWNOUT WAN transport/stream which is most suitable according to the applicable criteria for the classification of the IP flow.

At block 360, if the method 300 determines there are no BROWNOUT WAN transport/streams in block 345, the method 300 may only have BLACKOUT WAN transport/streams presently (as determined at block 330) in the direction determined in block 310. In some implementations, the method 300 may discard packets in the IP flow at block 360 while there are only BLACKOUT WAN transport/streams in the determined direction. In some implementations, such discards may continue until the status of one or more WAN transport/streams in the determined direction is no longer in BLACKOUT.

As stated above, any of the blocks in FIG. 3 may occur in a different order and/or parallel/concurrently, may not be performed, and/or may be performed multiple times. Accordingly, in some implementations, blocks 330, 335, 340, 345, 350, and 360 may be performed substantially concurrently. In some implementations, if the status of all WAN transport/streams is BLACKOUT in block 330, the method may stop, timeout, and/or keep re-performing block 330 until one or more WAN transport/streams are BROWNOUT and/or CLEAN.

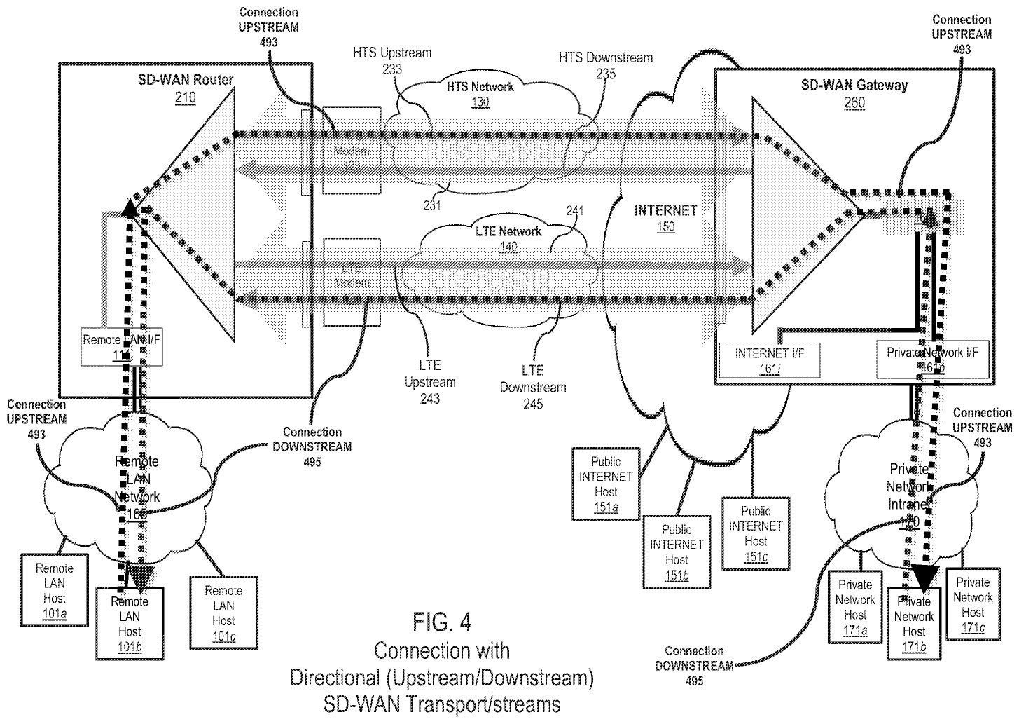

FIG. 4 is a block diagram illustrating the SD-WAN communication system of FIGS. 2A-2C separately routing the upstream and the downstream of a single communication connection over separate directional SD-WAN transport/streams on different WAN transports, according to an example. Because many components in FIG. 4 are similar in nature and function to the components in FIGS. 1A-1D and 2A-2C, they may be identified by the same reference numerals. The SD-WAN communication system depicted in FIG. 4 is provided for purposes of illustrating aspects, features, characteristics, and/or components relevant and/or germane to examples and/or implementations of the present disclosure, and thus, it should be appreciated that FIG. 4 may omit aspects, features, characteristics, and/or components not germane to examples and/or implementations of the present disclosure, as would be understood by one of ordinary skill in the art; moreover, some of the aspects, features, characteristics, and/or components described herein may be removed from and/or modified in the SD-WAN communication system shown in FIG. 4 without departing from the scope of the examples and/or implementations of the present disclosure, as would also be understood by one of ordinary skill in the art.

FIG. 4 includes, similar to FIG. 2A, the SD-WAN Router 210 having its Remote LAN I/F 111 and its connected HTS Modem 123 and LTE Modem 124; the HTS Network 130; the LTE Network 140; the Internet 150 connected to Public Internet Host(s) 151; the SD-WAN Gateway 260 directly connected to the Internet 150 and having its Internet I/F 161i and Private Network I/F 161p; the Private Network Intranet 170 connected to Private Network Host(s) 171; and the Remote LAN Network 105 connected to Remote LAN Host(s) 101. FIG. 4 includes, similar to FIG. 2A, two directional streams for each of the WAN transports (i.e., four WAN transport/streams in all): namely, the HTS Upstream 233 and the HTS Downstream 235 in the HTS Tunnel 231, and the LTE Upstream 243 and the LTE Downstream 245 in the LTE Tunnel 241. Because the WAN transport/streams in examples and/or implementations in accordance herein may have their own distinct operational status separate from their tunnels, the upstream and the downstream of any connection may be provisioned separately, thereby increasing efficiency.

As shown in FIG. 4 the Remote LAN host 101b may have a connection with the Private Network host 171b, where that connection is carried over the WAN transports between SD-WAN Router 210 and SD-WAN Gateway 260. The connection between the Remote LAN host 101b and the Private Network host 171b may employ the HTS Tunnel 231 and/or the LTE Tunnel 241.

In accordance with examples and/or implementations, the packets, groups of packets, and/or IP flow(s) constituting the connection between the Remote LAN host 101b and the Private Network host 171b may be transmitted on different WAN transport/streams in different directions based on the operational status of individual WAN transport/streams in each direction. In some implementations, the SD-WAN Router 210 may perform path selection for the connection in the upstream direction using a method similar to the method described in reference to FIG. 3, whereas the SD-WAN Gateway 260 may perform path selection for the connection in the downstream direction using a method similar to the method described in reference to FIG. 3. In some implementations, either the SD-WAN Router 210 or the SD-Wan Gateway 260 may perform path selection for both the upstream and the downstream and communicate the appropriate selected path to the other component for implementation.

As shown in FIG. 4, the connection between the Remote LAN host 101b and the Private Network host 171b includes an Upstream component 493 and a Downstream component 495. In examples and/or implementations in accordance herein, the Upstream component 493 may be transmitted on either the HTS Upstream 233 or the LTE Upstream 243 and the Downstream component 495 may be transmitted on either the HTS Downstream 235 or the LTE Downstream 245.

As shown in FIG. 4, the Upstream component 493 of the connection between the Remote LAN host 101b and the Private Network host 171b is being carried by the WAN transport/stream HTS Upstream 233 while the Downstream component 495 of the connection between the Remote LAN host 101b and the Private Network host 171b is being carried by the WAN transport/stream LTE Downstream 245. In some implementations, the Upstream component 493 may be carried by the HTS Upstream 233 rather than the LTE Upstream 243 because any of: (1) the HTS Upstream 233 was CLEAN while the LTE Upstream 243 was in BROWNOUT or BLACKOUT; (2) the HTS Upstream 233 was in BROWNOUT while the LTE Upstream 243 was in BLACKOUT; (3) both the HTS Upstream 233 and the LTE Upstream 243 were CLEAN but the HTS Upstream 233 had more suitable characteristics for the communication connection packet traffic (e.g., block 340 in FIG. 3); (4) both the HTS Upstream 233 and the LTE Upstream 243 were in BROWNOUT but the HTS Upstream 233 had more suitable characteristics for the communication connection packet traffic (e.g., block 350 in FIG. 3); or any other similar conditions and/or characteristics under which the HTS Upstream 233 may be preferable to the LTE Upstream 243 for the upstream communication connection packet traffic 493. Similarly, the Downstream component 495 may be carried by the LTE Downstream 245 rather than the HTS Downstream 235 because of any of the possible conditions and/or characteristics under which the LTE Downstream 245 may be preferable to the HTS Downstream 235 for the downstream communication connection packet traffic 495, as would be understood by one of ordinary skill.

As shown by FIGS. 2A-2C, 3, and 4, each of the upstream and downstream directions of a WAN transport employed in an SD-WAN communication system in accordance herewith may be given a different operational status (i.e., CLEAN, BROWNOUT, or BLACKOUT), and thus the upstream and downstream components of an SD-WAN connection may be assigned to different WAN transports.

### Application Group Categorization, Thresholds, and Path Selection

According to an example, the applicable criteria for classification of SD-WAN transport communication traffic may be according to application group, which are defined as two separate groups:
Interactive—low latency may be the priority.
Bulk Transfer—low cost may be the priority.

According to an example, the WAN transports employed in the SD-WAN communication system may be HTS and LTE (such as may carry, e.g., the HTS Tunnel 231 and the LTE Tunnel 241 in FIGS. 2A-2C and 4), and may have the following characteristics:
HTS—typically high capacity, high latency, and low cost.
LTE—typically highly variable capacity, low latency, and high cost.

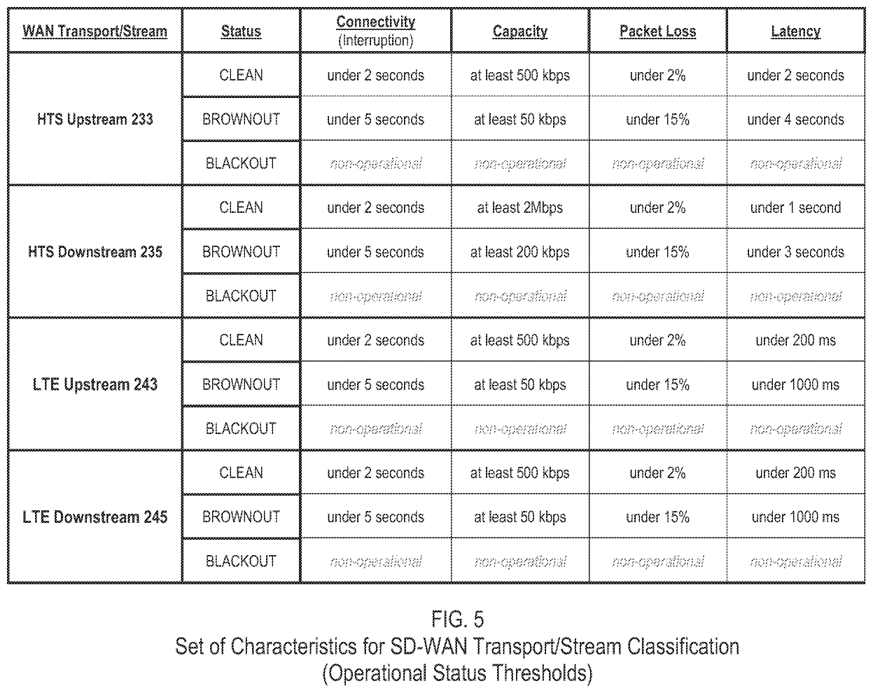

Accordingly, each WAN transport/stream may be characterized for separate classification, as shown by the example in FIG. 5.

FIG. 5 is a table showing one set of possible packet traffic performance characteristics for defining the operational status of each directional SD-WAN transport/stream, according to an example. The set of directional SD-WAN transport/stream characteristics in FIG. 5 is provided for purposes of illustrating examples and/or implementations of the present disclosure, and thus, it should be appreciated that the set in FIG. 5 lists only some characteristics, and that other examples and/or implementations may list less characteristics or many more characteristics (such as, e.g., jitter, usage cost, reliability, present traffic load, and the like) without departing from the scope of the examples and/or implementations of the present disclosure, as would be understood by one of ordinary skill in the art.

As shown in FIG. 5, the HTS Upstream 233 in FIGS. 2A-2C and 4 may have different operational thresholds than the HTS Downstream 235 in FIGS. 2A-2C and 4. For instance, the CLEAN status for the HTS Downstream 235 may have a capacity of at least 2 Mbps, while the CLEAN status for the HTS Upstream 233 may have a capacity of at least 500 kbps. Similarly, the HTS Upstream 233 in FIGS. 2A-2C and 4 may have different operational thresholds than the LTE Upstream 243 in FIGS. 2A-2C and 4. For instance, the CLEAN status for the HTS Upstream 233 may have a latency of under 2 seconds, while the CLEAN status for the LTE Upstream 243 may have a latency of under 200 ms. By allowing such differing characteristics for the operational status (i.e., CLEAN, BROWNOUT, or BLACKOUT) of individual WAN transport/streams according to any sort of classification system, examples and/or implementations as described herein allow for improved network efficiency.

FIG. 5 shows a single set of WAN transport/stream characteristics defining operational status according to an example. In some implementations, one set of WAN transport/stream characteristics may be employed for the operational status on all SD-WAN communication traffic (in other words, there may be effectively only one classification). In some implementations, different sets of communication traffic characteristics may be employed to define the operational status of individual WAN transport/streams according to different application sets or groups (such as, e.g., streaming video, video conferencing, web browsing, domain name lookups, gaming downloads, streaming active gaming, and the like). In other implementations, different sets of traffic characteristics for defining the operational status of individual WAN transport/streams may be employed based on classification by application, policy, priority, service classification, transport mode, VPN tunnel, Quality of Service (QOS), Quality of Experience (QoE), and/or by any of the various classification schemes which may be used in an SD-WAN communication system, as would be understood by one of ordinary skill in the art.

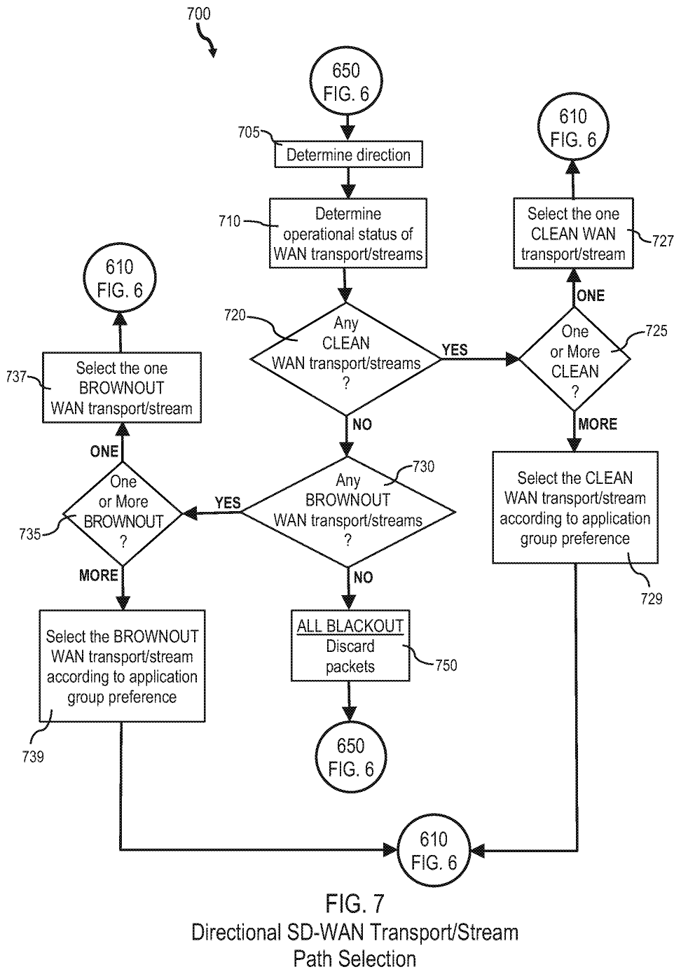

In implementations using the HTS/LTE SD-WAN communication system as discussed above in reference to the operational status table of FIG. 5, path selection for an IP flow may occur in accordance with the state diagram shown in FIG. 6, and may be implemented in accordance with the flow diagram shown in FIG. 7.

FIG. 6 is a state diagram illustrating when path selection may be performed in a directional SD-WAN transport/stream classification system, according to an example. More specifically, FIG. 6 illustrates the possible events causing a transition from a traffic flow steady state to a path selection state. The example of FIG. 6 is employed to illustrate the traffic flow steady state and the path selection state in FIG. 7 further below, but may be employed in any of the methods shown and described in relation to any of FIG. 3, 8, 9, or 10 herein. The path selection state diagram depicted in FIG. 6 is provided to illustrate aspects, characteristics, and/or features relevant and/or germane to examples and/or implementations of the present disclosure, and thus, it should be appreciated that FIG. 6 may omit aspects, characteristics, and/or features not germane to examples and/or implementations of the present disclosure, as would be understood by one of ordinary skill in the art; moreover, there may be multiple other forms, types, and/or examples of transitions and/or states applicable to the examples and/or implementations of the present disclosure, and thus FIG. 6 is non-limiting in nature, as would also be understood by one of ordinary skill in the art.

FIG. 6 shows two states: a FLOW STATE 610 and a SELECTION STATE 650, with multiple transition events between the two. In the FLOW STATE 610, the SD-WAN communication traffic flows in accordance with applicable policies, protocols, and on selected SD-WAN transport/streams. As shown in FIG. 6, one or more transition events may occur which will cause the system to go into the SELECTION STATE 650. In some implementations, a PERIODIC transition event 620 may cause a transition to the SELECTION STATE 650—i.e., after a predetermined period of time, the system may perform path selection. In some implementations, a CHANGE in APP./GROUP transition event 630 may cause a transition to the SELECTION STATE 650—i.e., if there has been a change in the application group status of an IP flow and/or a change in the application status of an IP flow, the system may perform path selection for at least that IP flow. The change in APP./GROUP may occur just based on the change in an IP flow's traffic characteristics. For example, a VPN flow may switch from being an interactive VPN flow (based on its traffic rate) to a bulk transfer VPN flow just based on the amount of traffic being carried.

In some implementations, a CHANGE in WAN TRANSPORT/STREAM STATUS transition event 640 may cause a transition to the SELECTION STATE 650—i.e., if there has been a change in status for the upstream and/or downstream of any of the WAN transports, the system may perform path selection for at least any IP flows on the changed WAN transport/upstream and/or WAN transport/downstream. In other implementations, other events may cause the transition from the FLOW STATE 610 to the SELECTION STATE 650, such as, for example, a change in status of the SD-WAN Router 210 and/or the SD-WAN Gateway 260; a change in conditions at one of the end points of the connection (e.g., one of the Remote LAN Host(s) 101, Public Internet Host(s) 151, and/or Private Network Host(s) 171); and/or other changes in the overall SD-WAN communication system, as would be understood by one of ordinary skill in the art.

In the SELECTION STATE 650, the system performs path selection, i.e., determines which of the WAN transport/streams a connection and/or IP flow may use, e.g., either the HTS Upstream 233 or LTE Upstream 243 for the upstream and either the HTS Downstream 235 or LTE Downstream 245 for the downstream of the particular WAN transport. In some implementations, the method 300 in FIG. 3 may be employed; in some implementations, the method 700 in FIG. 7 described below may be employed; in yet other implementations, other methods in accordance with the present disclosure may be employed. After path selection is performed in SELECTION STATE 650, the system has a RETURN event 660, where the system returns to the FLOW STATE 610, and the SD-WAN communication traffic flows in accordance with applicable policies, protocols, and the like, on selected SD-WAN transport/streams.

FIG. 7 illustrates a flow diagram of a method 700 of directional SD-WAN transport/stream path selection in an SD-WAN communication system, according to an example. The method 700 shown in FIG. 7 is provided by way of example and may only be one part of an entire process/procedure. As mentioned above, and shown in detail below, the example of FIG. 6 is employed to illustrate the traffic flow steady state and the path selection state in FIG. 7. The method 700 may further omit parts of the method not germane to the present disclosure, as would be understood by one of ordinary skill in the art. Each block shown in FIG. 7 may further represent one or more steps, processes, methods, or subroutines, as would be understood by one of ordinary skill in the art. For the sake of convenience and ease of explanation, the blocks in FIG. 7 may refer to the components and/or descriptions of some of the other figures described herein; however, the method 700 is not limited in any way to the components, apparatuses, and/or constructions shown in any of the figures described herein. It may be appreciated by one of ordinary skill in the art that, in various implementations in accordance with the present disclosure, any of the blocks in FIG. 7 may occur in a different order and/or simultaneously (e.g., in parallel and/or concurrently), may not be performed, and/or may be performed multiple times.

In some implementations, the method 700 may be applied at different levels of granularity, e.g., to a connection as a whole, on an IP flow basis (e.g., for each individual IP flow with a connection being assigned separately), to groups of packets, or even to individual packets. As shown in FIG. 7, the timing of the path selection may be in accordance with the state diagram of FIG. 6, i.e., periodically, when there is a change in the communication system (such as a change in, e.g., operational status of a WAN transport or a WAN transport/stream), and/or when there is a change in the communication traffic. However, in other implementations, the method 700 of path selection may be performed at different times, under different conditions, and/or for different purposes.

In FIG. 7, as discussed above, the system may employ HTS and LTE WAN transports; the SD-WAN transport communication traffic may be classified according to two application groups, Interactive and Bulk; and the operational status of each individual WAN transport/stream may be determined in accordance with the operational status table of FIG. 5. In some implementations, the SD-WAN transport communication traffic may be packet traffic from, using FIG. 2A as an illustrative example, a Remote LAN Host 101 through an SD-WAN Router 210, one or more HTS and LTE WAN transports, and an SD-WAN Router 160 to a Public Internet Host 151 or a Private Network Host 171.

At block 705, after the system has entered the SELECTION STATE 650 in FIG. 6, the method 700 may determine the direction of the SD-WAN communication traffic being routed, i.e., whether the packet traffic, and thus the available WAN transport/streams to be selected, are either upstream or downstream.

At block 710, the method 700 may determine the operational status of the available WAN transport/streams (in the direction determined in block 710). In some implementations, the available WAN transport/streams may be any of HTS Upstream 233 and LTE Upstream 243 in the upstream in FIG. 2A, and any of HTS Downstream 235 and LTE Downstream 245 in the downstream in FIG. 2A. In some implementations, the method 700 in block 710 may classify any of HTS Upstream 233,

HTS Downstream 235, LTE Upstream 243, and/or LTE Downstream 245 as CLEAN, BROWNOUT, and BLACKOUT in accordance with the table in FIG. 5. For instance, if the current measured latency of the HTS Upstream 233 was roughly 3 seconds, its operational status would be BROWNOUT, whereas if the current measured latency of the LTE Upstream 243 was roughly 3 seconds, its operational status would be BLACKOUT. As another instance, if the current measured capacity of the HTS Downstream 235 was roughly 100 kbps, its operational status would be BLACKOUT, whereas if the current measured capacity of the LTE Downstream 245 was roughly 100 kbps, its operational status would be BROWNOUT.

At block 720, the method 700 may determine whether any of the WAN transport/streams were classified as CLEAN in block 710. If the method 700 determines there are CLEAN WAN transport/streams in block 720, the method 700 continues at block 725 to determine whether there are one or more CLEAN WAN transport/streams. If there is only one CLEAN WAN transport/stream at block 725, the method continues to block 727 to select that Clean WAN transport/stream for the SD-WAN communication traffic in the determined direction (i.e., upstream or downstream), and then the method 700 returns to the FLOW STATE 610 in FIG. 6. If there is more than one CLEAN WAN transport/stream at block 725, the method continues to block 729 to select the Clean WAN transport/stream according to the application group's preference. In some implementations where the application groups are defined as Interactive and Bulk Transfer and the WAN transports are HTS and LTE, the method 700 at block 729 may select the CLEAN WAN transport/stream with the lowest latency if the application group of the SD-WAN communication traffic is Interactive, or the CLEAN WAN transport/stream with the lowest cost if the application group of the SD-WAN communication traffic is Bulk Transfer. After the suitable/appropriate CLEAN WAN transport/stream is selected in block 729, the method 700 returns to the FLOW STATE 610 in FIG. 6.

In other implementations, the method 700 at block 729 may have alternative and/or additional criteria for selecting which of the multitude of available CLEAN WAN transport/streams to use. In some implementations, such alternative and/or additional criteria may be, e.g., gradations of latency sensitivity of the SD-WAN communication traffic (such as, e.g., traffic requiring very low latency vs. traffic requiring low latency), the level of interactivity of the SD-WAN communication traffic, the backlog of packets awaiting transmission, the expected latency of the WAN transport/stream, the target bit rate, the baseline latency, the queue depth, system requirements such as load balancing, and the like, as would be understood by one of ordinary skill in the art. For instance, the '920 patent, the '782 patent, and the '760 patent may be referred to for more in-depth discussions of possible alternative and/or additional criteria for selecting among a set of CLEAN WAN transport/streams. As an example, the handshake packets during the initial establishment of an HTTPS connection or the packets forming the body of a web page may have alternative and/or additional criteria for selecting among a set of CLEAN WAN transport/streams such as the lowest expected latency given the estimated capacity, measured latency, and backlog of packets awaiting transmission.

At block 730, having already determined there are no CLEAN WAN transport/streams in block 720, the method 700 may determine whether any of the WAN transport/streams were classified as BROWNOUT in block 710. If the method 700 determines there are BROWNOUT WAN transport/streams in block 730, the method 700 continues at block 735 to determine whether there are one or more BROWNOUT WAN transport/streams. If there is only one BROWNOUT WAN transport/stream at block 735, the method continues to block 737 to select that BROWNOUT WAN transport/stream for the SD-WAN communication traffic in the determined direction (i.e., upstream or downstream), and then the method 700 returns to the FLOW STATE 610 in FIG. 6. If there is more than one BROWNOUT WAN transport/stream at block 735, the method continues to block 739 to select the BROWNOUT WAN transport/stream according to the application group's preference. In some implementations where the application groups are defined as Interactive and Bulk Transfer and the WAN transports are HTS and LTE, the method 700 at block 739 may select the BROWNOUT WAN transport/stream with the lowest latency if the application group of the SD-WAN communication traffic is Interactive, or the BROWNOUT WAN transport/stream with the lowest cost if the application group of the SD-WAN communication traffic is Bulk Transfer. After the suitable/appropriate BROWNOUT WAN transport/stream is selected in block 739, the method 700 returns to the FLOW STATE 610 in FIG. 6.

In other implementations, the method 700 at block 739 may have alternative and/or additional criteria for selecting which of the multitude of available BROWNOUT WAN transport/streams to use. In some implementations, such alternative and/or additional criteria may be, e.g., gradations of latency sensitivity of the SD-WAN communication traffic (such as, e.g., traffic requiring very low latency vs. traffic requiring low latency), the level of interactivity of the SD-WAN communication traffic, the backlog of packets awaiting transmission, the expected latency of the WAN transport/stream, the target bit rate, the baseline latency, the queue depth, system requirements such as load balancing, and the like, as would be understood by one of ordinary skill in the art. For instance, the '920 patent, the '782 patent, and the '760 patent may be referred to for more in-depth discussions of possible alternative and/or additional criteria for selecting among a set of BROWNOUT WAN transport/streams. As an example, the handshake packets during the initial establishment of an HTTPS connection or the packets forming the body of a web page may have alternative and/or additional criteria for selecting among a set of BROWNOUT WAN transport/streams such as the lowest expected latency given the estimated capacity, measured latency, and backlog of packets awaiting transmission.

At block 750, if the method 700 determines there are no BROWNOUT WAN transport/streams in block 730, there may at present only be BLACKOUT WAN transport/streams (as determined at block 710) in the direction determined in block 705. In some implementations, because there are only BLACKOUT WAN transport/streams in the determined direction, the method 700 may discard packets of the present SD-WAN communication connection at block 750. In some implementations, after such discards in block 750, the method 700 returns to the SELECTION STATE 650 in FIG. 6, which effectively re-starts method 700 at block 705. Accordingly, such discards may continue until the status of one or more WAN transport/streams in the determined direction is no longer in BLACKOUT.

As stated above, any of the blocks in FIG. 7 may occur in a different order and/or parallel/concurrently, may not be performed, and/or may be performed multiple times. Accordingly, in some implementations, blocks 720, 725, 727, and 729 and/or blocks 730, 735, 737, and 739 may be performed substantially concurrently. In some implementations, the component performing method 700 may only select the WAN transport/streams for packets going in one direction and thus block 705 may be omitted (for example, the SD-Wan Router 210 may only select the upstream WAN transport/streams and/or the SD-Wan Gateway 260 may only select the downstream WAN transport/streams). In some implementations, the component performing method 700 may select the WAN transport/streams for both directions and thus block 705 may be omitted and the remaining blocks are performed for both upstream and downstream WAN transport/streams (for example, the SD-Wan Router 210 may select both the upstream WAN transport/streams and the downstream WAN transport/streams, and then transmit the selected downstream WAN transport/streams to the SD-Wan Gateway 260 for appropriate packet routing).

### Directional SD-WAN Transport/Stream Operational Status—Method(s)

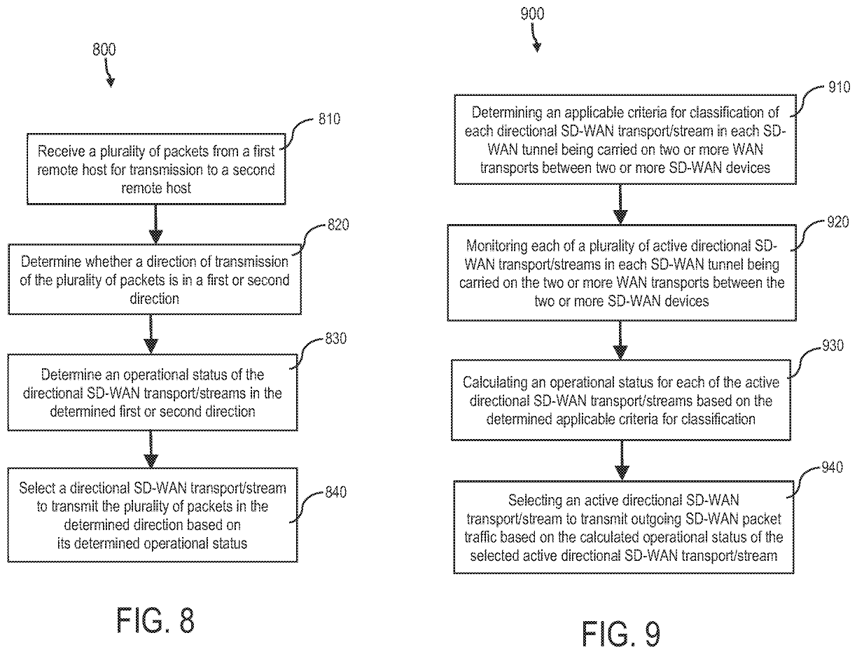

FIGS. 3 and 7, described and discussed in detail above, provide two methods of path selection for selecting/assigning a directional SD-WAN transport/stream to packet traffic in an SD-WAN communication system based on operational status. FIGS. 8, 9, and 10, described and discussed in detail below, provide three methods of path selection for selecting/assigning a directional SD-WAN transport/stream to packet traffic in an SD-WAN communication system based on operational status. As would be understood by one of ordinary skill in the art, the methods shown in FIGS. 3, 7, 8, 9, and 10 are examples, which may overlap and diverge in content, form and flow, and which are intended to illustrate the breadth and depth of examples and/or implementations of the present disclosure, and should be interpreted, in context and in light of each other, as intended to increase the scope of the examples and/or implementations of the present disclosure.

Each of FIGS. 8, 9, and 10 illustrates a flow diagram of a method 800, a method 900, and a method 1000, respectively, for selecting/assigning a directional SD-WAN transport/stream to SD-WAN packet traffic based on operational status, according to examples and/or implementations. Like the methods 300 and 700 in FIGS. 3 and 7, respectively, the methods 800, 900, and 1000 shown in FIGS. 8, 9, and 10, respectively, are provided by way of example and may only be one part of an entire process/procedure. Each of the methods 800, 900, and/or 1000 may further omit parts of the method not germane to the present disclosure, as would be understood by one of ordinary skill in the art. Each block shown in FIGS. 8, 9, and/or 10 may further represent one or more steps, processes, methods, or subroutines, as would be understood by one of ordinary skill in the art. For the sake of convenience and ease of explanation, the blocks in FIGS. 8, 9, and/or 10 may refer to the components and/or descriptions of some of the other figures described herein; however, the methods 800, 900, and 1000 are not limited in any way to the components, apparatuses, and/or constructions shown in any of the other figures described herein. It may be appreciated by one of ordinary skill in the art that, in various implementations in accordance with the present disclosure, any of the blocks in FIGS. 8, 9, and/or 10 may occur in a different order and/or simultaneously (e.g., in parallel and/or concurrently), may not be performed, and/or may be performed multiple times.

In some implementations, the method 800, the method 900, and/or the method 1000 in FIGS. 8, 9, and/or 10, respectively, may be applied at different levels of granularity, such as to an individual IP flow, to a connection as a whole (and each IP flow therein), to groups of packets, or even to individual packets, and the like, as would be understood by one of ordinary skill in the art. In some implementations, the method 800, the method 900, and/or the method 1000 of selecting/assigning an SD-WAN transport/stream to SD-WAN packet traffic may be performed at different times, under different conditions, and/or for different purposes. In some implementations, such as shown in the state diagram of FIG. 6 above, the method 800, the method 900, and/or the method 1000 of selecting/assigning an SD-WAN transport/stream to SD-WAN packet traffic may be performed when there is a change in the communication system (such as a change in, e.g., operational status of a WAN transport or a WAN transport/stream), a change in the communication traffic, and/or after an elapsed time period (i.e., path selection may be automatically performed periodically).

In some implementations, the method 800, the method 900, and/or the method 1000 in FIGS. 8, 9, and/or 10, respectively, may be performed by an SD-WAN device, such as, e.g., the SD-WAN Router 210 of FIGS. 2A-2C and 4 and the SD-WAN Gateway 260 of FIGS. 2A-2C and 4. In some implementations, the processors 214 and/or 264 of the SD-WAN Router 210 and the SD-WAN Gateway 260, respectively, may perform one or more of the blocks of the method 800, the method 900, and/or the method 1000 in FIGS. 8, 9, and/or 10, respectively, by executing instructions stored on memories 216 and/or 266. In some implementations, an SD-WAN device having components like those illustrated in FIG. 11 may perform one or more of the blocks of the method 800, the method 900, and/or the method 1000 in FIGS. 8, 9, and/or 10, respectively.

The method 800 of FIG. 8 follows:

At block 810, an SD-WAN device may receive a plurality of packets from a first remote host to transmit to a second remote host. In some implementations, the first remote host may be the Remote LAN Host 101b and the second remote host may be the Private Network Host 171b. In some implementations, either the first remote host or the second remote host ay be any of the first remote host comprises one of a remote local area network (LAN) host, an Internet host, or a private network host.

At block 820, the SD-WAN device may determine whether a transmission direction of the plurality of packets is in the first direction or in the second direction. In some implementations, the first direction may be upstream, and the second direction may be downstream.

At block 830, the SD-WAN device may determine an operational status of each of the active directional SD-WAN transport/streams in the determined direction. In some implementations, the SD-WAN device may have one or more SD-WAN tunnels (such as, e.g., HTS Tunnel 231 and LTE Tunnel 241 in FIGS. 2A-2C and 4), and may determine the operational status of each of the directional SD-WAN transport/streams of the one or more SD-WAN tunnels in the determined direction (such as, e.g., the HTS Upstream 233 and the LTE Upstream 243 in FIGS. 2A-2C and 4 if the determined direction is upstream, or the HTS Downstream 235 and the LTE Downstream 245 in FIGS. 2A-2C and 4 if the determined direction is downstream). In some implementations, the operational status may be one of CLEAN, BROWNOUT, or BLACKOUT.

In some implementations, a set of packet traffic characteristics such as shown in, e.g., FIG. 5, may be employed in block 830 to determine the operational status of each active directional SD-Wan transport/stream. In some implementations, the packet traffic characteristics may include, for example, connectivity, capacity, packet loss, latency, jitter, usage cost, service classification, Quality of Service (QOS), reliability, Quality of Experience (QoE), traffic load, traffic type, or any other packet traffic performance metric, as would be understood by one of ordinary skill in the art.

At block 840, the SD-WAN device may select a directional SD-WAN transport/stream to transmit the plurality of packets in the determined direction based on its determined operational status. In some implementations, the selection of the directional SD-WAN transport/stream in block 840 may be performed similarly to the method 300 in FIG. 3 and/or the method 700 in FIG. 7.

The method 900 of FIG. 9 follows:

At block 910, an SD-WAN device may determine an applicable criteria for classification of each directional SD-WAN transport/stream in each SD-WAN tunnel being carried on two or more of a plurality of WAN transports between two or more SD-WAN devices, wherein the applicable criteria for classification is a set of packet traffic characteristics defining an operational status of a directional SD-WAN transport/stream. As noted above, the term “criteria” as used herein may refer to either or both the singular (“criterion”) and the plural, similarly to how the terms “agenda” and “data” are also used commonly, concisely, and clearly for both the singular and the plural in English usage.

In some implementations, determining the applicable criteria for classification in block 910 may be based on, e.g., any one or more of the direction of the packet traffic, the application or application group, the service class, the transport mode (TM), the virtual private network (VPN), the type, the priority, the rule, and/or any other salient or suitable factor, feature, or characteristic of packet traffic, and the like, as would be understood by one of ordinary skill in the art. In some implementations, determining the applicable criteria for classification may be based on, e.g., the type of the WAN connections, the condition of the WAN connections, a number of SD-WAN tunnels, the types of SD-WAN tunnels, the condition of the SD-WAN tunnels, the number of the directional SD-WAN transport/streams in the direction of the packet traffic, the type of the directional SD-WAN transport/streams in the direction of the packet traffic, the condition of the directional SD-WAN transport/streams in the direction of the packet traffic, and/or any other salient or suitable factor, feature, or characteristic of any of the communication paths, links, tunnels, connections, and the like, as would be understood by one of ordinary skill in the art.

At block 920, the SD-WAN device may monitor each of the active directional SD-WAN transport/streams in each SD-WAN tunnel being carried on the two or more WAN transports between the two or more SD-WAN devices. In some implementations, the SD-WAN device may monitor any packet traffic characteristics of the active directional SD-WAN transport/streams, such as, e.g., connectivity, capacity, packet loss, latency, jitter, usage cost, service classification, Quality of Service (QOS), reliability, Quality of Experience (QoE), traffic load, traffic type, or any other packet traffic performance metric, as would be understood by one of ordinary skill in the art.

At block 930, the SD-WAN device may calculate an operational status for each of the active directional SD-WAN transport/streams based on the determined applicable criteria for classification from block 910. In some implementations, the operational status may be one of CLEAN, BROWNOUT, or BLACKOUT. In some implementations, the operational status may be calculated differently for different directional SD-WAN transport/streams (e.g., the latency threshold for BROWNOUT for the directional SD-WAN transport/stream in one WAN transport may be different than the latency threshold for BROWNOUT for the directional SD-WAN transport/stream in another, different WAN transport).

At block 940, the SD-WAN device may select a directional SD-WAN transport/stream from among the active directional SD-WAN transport/streams to transmit outgoing SD-WAN packet traffic between the two or more SD-WAN devices, based on the calculated operational status of the selected active directional SD-WAN transport/stream calculated in block 930.

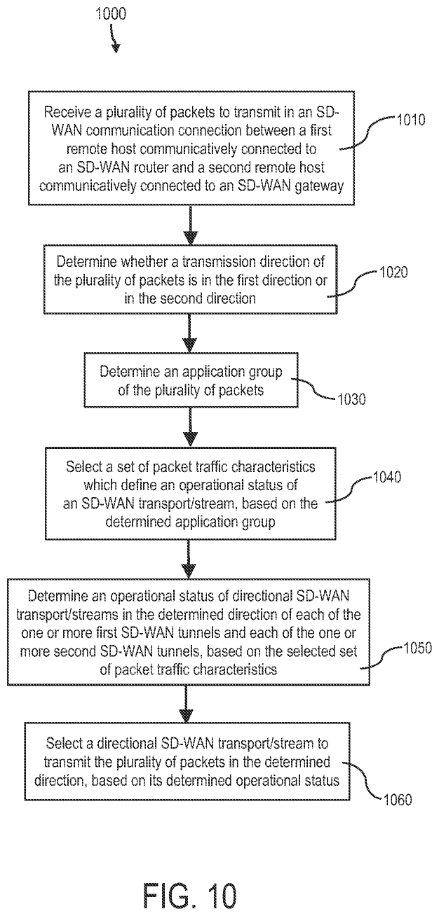

The method 1000 of FIG. 10 follows:

One or more processors may perform one, more and/or all of the blocks in the method 1000 of FIG. 10. In some implementations, the one or more processors may be the processor 214 of the SD-WAN Router 210 and/or the processor 264 of the SD-WAN Gateway 260, respectively, executing instructions stored on the memory 216 of the SD-WAN Router 210 and/or the memory 266 of the SD-WAN Gateway 260 in FIGS. 2A-2C and 4. In some implementations, the one or more processors may be the processor 1170 in FIG. 11 described further below. In some implementations, the one or more processors may not be located in an SD-WAN router nor an SD-WAN gateway, but rather may be communicatively coupled to an SD-WAN router and/or an SD-WAN gateway.

At block 1010, a plurality of packets may be received for transmission from a first remote host communicatively connected to an SD-WAN router over an SD-WAN communication connection to a second remote host communicatively connected to an SD-WAN gateway. The SD-WAN router and the SD-WAN gateway may be connected by a first WAN connection which includes a satellite network and a second WAN connection which includes a wireless cellular network, and the SD-WAN router and the SD-WAN gateway may maintain the SD-WAN communication connection over one or more SD-WAN tunnels on the first and second WAN connections. Each of the one or more SD-WAN tunnels includes a directional SD-WAN transport/stream in a first direction (e.g., upstream) and a directional SD-WAN transport/stream in a second direction (e.g., downstream). In some implementations, an SD-WAN router may be the SD-WAN Router 210 and the first remote host may be a Remote LAN Host 101 in FIGS. 2A-2C and 4. In some implementations, an SD-WAN gateway may be the SD-WAN Gateway 260 and the second remote host may be a Public Internet Host 151 and/or a Private Network Host 171 in FIGS. 2A-2C and 4.

At block 1020, one or more processors may determine whether a transmission direction of the plurality of packets is in the first direction or in the second direction. In some implementations, the first direction is from the SD-WAN router to the SD-WAN gateway and may be referred to as “upstream.” In some implementations, the second direction is from the SD-WAN gateway to the SD-WAN router and may be referred to as “downstream.”

At block 1030, one or more processors may determine an application group of the plurality of packets. In some implementations, the one or more processors may determine in block 1030 whether the SD-WAN communication connection of the plurality of packets is interactive or for bulk transfer. In other implementations, the one or more processors may determine in block 1030 another, different attribute by which a set of packet characteristics may be selected in block 1040, such as, e.g., any one or more of the service class, the transport mode (TM), the virtual private network (VPN), the type, the priority, the rule, and/or any other salient or suitable factor, feature, or characteristic of packet traffic, and the like, as would be understood by one of ordinary skill in the art. In some implementations, the attribute determined in block 1030 may be, e.g., the type and/or condition of the WAN connections; the number, type(s), and/or condition(s) of the SD-WAN tunnels; the number, type(s), and/or condition(s) of the directional SD-WAN transport/streams in the direction of the packet traffic; and/or any other salient or suitable factor, feature, or characteristic of any of the communication paths, links, tunnels, connections, and the like, as would be understood by one of ordinary skill in the art.

At block 1040, one or more processors may select a set of packet traffic characteristics which define an operational status of an SD-WAN transport/stream, based on the determined application group. In some implementations, the set of packet traffic characteristics may be similar to the table of packet traffic performance characteristics in FIG. 5. In some implementations, other packet traffic characteristics may be included, such as, e.g., jitter, usage cost, service classification, Quality of Service (QOS), reliability, Quality of Experience (QoE), traffic load, traffic type, or any other packet traffic performance metric, as would be understood by one of ordinary skill in the art.

At block 1050, one or more processors may determine an operational status of directional SD-WAN transport/streams in the determined direction of each of the one or more first SD-WAN tunnels and each of the one or more second SD-WAN tunnels, based on the selected set of packet traffic characteristics. In some implementations, the one or more processors may assign an operational status of one of CLEAN, BROWNOUT, or BLACKOUT to each of the directional SD-WAN transport/streams in the determined direction.

At block 1060, one or more processors may select a directional SD-WAN transport/stream to transmit the plurality of packets in the determined direction, based on its determined operational status.

FIG. 11 illustrates a computer system 1100 in which or with which examples of the present systems may be implemented. In particular, any of the the SD-WAN Router 210 and/or the SD-WAN Gateway 260 as shown in FIGS. 2A-2C and/or 4 may be implemented as the computer system 1100. In other words, while generically illustrated, the computer system 1100 may be the central processing unit (CPU) of the SD-WAN Router 210 and/or the SD-WAN Gateway 260 and may control overall operation of the SD-WAN Router 210 and/or the SD-WAN Gateway 260. Moreover, any of the methods, functions, and/or processes described herein, such as the methods in FIGS. 3 and 7 and the state diagram in FIG. 6, may be performed by the computer system 1100.

In some implementations, the SD-WAN Router 210 in FIG. 2B and/or the SD-WAN Gateway 260 in FIG. 2C may include one or more single- and/or multi-chip processors and/or one or more single- and/or multi-core processors employed for routing and/or applying policies (in such examples, the processor 214 of the SD-WAN Router 210 in FIG. 2B and/or the processor 264 of the SD-WAN Gateway 260 in FIG. 2C may be the one or more single- and/or multi-chip processors and/or the one or more single- and/or multi-core processors). In such implementations, any of the methods, functions, and/or processes described herein, such as the methods in FIGS. 3 and 7 and the state diagram in FIG. 6, may be performed by such one or more single- and/or multi-chip processors and/or one or more single- and/or multi-core processors. Moreover, in some examples and/or implementations, the various methods, functions, and/or processes described in reference to the processor 214 of the SD-WAN Router 210 in FIG. 2B and/or the processor 264 of the SD-WAN Gateway 260 in FIG. 2C may be broken down and separately performed by different functional components. For example, as mentioned above, the processor 214 of the SD-WAN Router 210 in FIG. 2B and/or the processor 264 of the SD-WAN Gateway 260 in FIG. 2C may not physically interact with each packet, but the SD-WAN Router 210 and/or the SD-WAN Gateway 260 may instead also include hardware that, once an IP flow has been identified and a policy set for it, applies that policy to the following packets in the identified IP flow without the processor 214 and/or the processor 264 being specifically involved.

Referring back to FIG. 11, the computer system 1100 may include an external storage device 1110, a bus 1120, a main memory 1130, a read-only memory 1140, a mass storage device 1150, communication port(s) 1160, and a processor 1170. A person skilled in the art will appreciate that the computer system 1100 may include more than one processor and communication ports. The communication port(s) 1160 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1160 may be chosen depending on a network, such a Local Area Network (LAN), Wide Area Network (WAN), or any network to which the computer system 1100 connects.

The main memory 1130 may be a non-transitory computer-readable storage medium having an executable stored thereon, which when executed instructs the processor 1170 to perform any of the methods and/or functions described herein. The main memory 1130 may be a standard computer-readable medium for storage and/or retrieval of information, such as a fixed disk drive (internal or external), and may be used, for example, to store and provide access to information pertaining to various operations of and in the SD-WAN Router 210 and/or the SD-WAN Gateway 260. The main memory 1130 may include, for example, random access memory (RAM), flash memory, or any other dynamic storage device commonly known in the art.

The read-only memory 1140 may be any static storage device(s) including, but not limited to, a Programmable Read Only Memory (PROM) chips for storing static information e.g., start-up or basic input/output system (BIOS) instructions for the processor 1170. The mass storage device 1150 may be any current or future mass storage solution, which may be used to store information and/or instructions, such as, for example, one or more hard disk drives and/or optical disk (e.g., CD or DVD) devices. The bus 1120 communicatively couples the processor 1170 with the other memory, storage, and communication blocks. The bus 1120 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1170 to the computer system 1100. Optionally, operator and administrative interfaces, e.g., a display, keyboard, and a cursor control device, may also be coupled to the bus 1120 to support direct operator interaction with the computer system 1100. Other operator and administrative interfaces may be provided through network connections connected through the communication port(s) 1160. In no way should the aforementioned exemplary computer system limit the scope of the presently described subject matter.

In some implementations, the processor 1170 may be, or may include, one or more programmable general-purpose or special-purpose single- and/or multi-chip processors, a single- and/or multi-core processors, microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices. Code or computer-readable instructions to implement the methods, functions, and/or operations described herein may be received by the processor 1170 via one or more interfaces and/or may be stored and retrieved by the processor 1170 from other memory, such as any of the main memory 1130, the read-only memory 1140, the mass storage device 1150, and/or other suitable storage device. An operating system may be provided by such means, including, e.g., MS-DOS®, MS-WINDOWS®, OS/2®, OS X®, IOS®, ANDROID®, UNIX®, Linux®, or another operating system, as would be understood by one of ordinary skill in the art.

In some implementations, the method or methods described above may be executed or carried out by the computing system 1100 including a tangible computer-readable storage medium, also described herein as a storage machine, that holds machine-readable instructions executable by a logic machine (i.e., a processor or programmable control device) to provide, implement, perform, and/or enact the above described methods, processes and/or tasks. The storage machine may be any one or more of the main memory 1130, the read-only memory 1140, and/or the mass storage device 1150 and thus code or computer-readable instructions to implement the methods and/or processes described herein may be stored in computer-readable storage media such as one or more of the main memory 1130, the read-only memory 1140, the mass storage device 1150, and/or other suitable storage device. When such methods and processes are implemented, the state of the storage machine may be changed to hold different data. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system 1100 may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption.

In some implementations, the computing system 1100 may include an input subsystem that receives user input. The input subsystem may be configured to connect to and receive input from devices such as a mouse, keyboard, or gaming controller. For example, a user input may indicate a request that certain task is to be executed by the computing system 1100, such as requesting the computing system 1100 to display any of the above-described information or requesting that the user input updates or modifies existing stored information for processing. A communication subsystem may allow the methods described above to be executed or provided over a computer network. For example, the communication subsystem may be configured to enable the computing system 1100 to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

However, as would be understood by one of ordinary skill in the art, FIG. 11 is an illustrative example, and non-limiting to the present disclosure. Generally speaking, any one or more of the components and/or functionalities described in reference to any of the FIGS. herein may be implemented by hardware, software, and/or any combination thereof, according to examples of the present disclosure. In some examples, the components and/or functionalities may be implemented by at least one of any type of application, program, library, script, task, service, process, or any type or form of executable instructions stored in a non-transitory computer-readable storage medium executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with one or more of a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

As mentioned above, what is shown and described with respect to the systems and methods above are illustrative. While examples and/or implementations described herein are directed to configurations as shown, it should be appreciated that any of the components described or mentioned herein may be altered, changed, replaced, or modified, in size, shape, and numbers, or material, depending on application or use case, and adjusted for particular implementations. It should also be appreciated that the systems and methods, as described herein, may also include, or communicate with, other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the systems described herein.

Moreover, single components may be provided as multiple components, and vice versa, to perform the functions and features described herein. It should be appreciated that the components of the system described herein may operate in partial or full capacity, or it may be removed entirely. It should also be appreciated that communication, monitoring, and processing techniques described herein, for example, may also be performed partially or in full by other various components of the overall system.

It should be appreciated that memories and/or data stores may also be provided to the apparatuses, systems, and methods described herein, and may include volatile and/or nonvolatile data storage that may store data and software or firmware including machine-readable instructions. The software or firmware may include subroutines or applications that perform the functions of the system and/or run one or more applications that utilize data from the system or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

Although some examples and/or implementations herein are directed to satellite communication systems, it should be appreciated that the systems and methods described herein may also be used in other various systems and other implementations. For example, these may include cable or optical communication systems, telecommunication systems, and/or other various satellite systems. By leveraging existing equipment, the system and methods described herein may provide efficient processing techniques and a cost-effective approach that may be readily integrated into various and existing network equipment. The systems and methods described herein may provide simplicity and adaptability to small or large satellite communication systems. Ultimately, the systems and methods described herein may increase efficiency, reduce cost, maximize existing equipment, minimize adverse effects of traditional systems, and improve satellite communication capabilities.

What has been described and illustrated herein are examples and/or implementations of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A software defined wide area network (SD-WAN) device, comprising:
a first SD-WAN interface with a first WAN connection;
a second SD-WAN interface with a second WAN connection;
one or more processors operatively coupled to the first SD-WAN interface and the second SD-WAN interface to maintain one or more first SD-WAN tunnels over the first WAN connection and one or more second SD-WAN tunnels over the second WAN connection,
wherein each of the one or more first SD-WAN tunnels comprises a first directional SD-WAN transport/stream in a first direction and a second directional SD-WAN transport/stream in a second direction, and
wherein each of the one or more second SD-WAN tunnels comprises a third directional SD-WAN transport/stream in the first direction and a fourth directional SD-WAN transport/stream in the second direction; and
a memory operatively coupled with the one or more processors, wherein the memory is to store instructions which, when executed by the one or more processors, cause the one or more processors to:
receive a plurality of packets from a first remote host to transmit to a second remote host;
determine whether a transmission direction of the plurality of packets is in the first direction or in the second direction;
determine an operational status of the directional SD-WAN transport/streams in the determined direction of each of the one or more first SD-WAN tunnels and each of the one or more second SD-WAN tunnels; and
select a directional SD-WAN transport/stream to transmit the plurality of packets in the determined direction based on its determined operational status.

2. The SD-WAN device of claim 1, further comprising:
a plurality of SD-WAN interfaces, wherein each of the plurality of SD-WAN interfaces has one or more WAN connections, including the first SD-WAN interface with the first WAN connection and the second SD-WAN interface with the second WAN connection.

3. The SD-WAN device of claim 1, wherein the operational status comprises one of CLEAN, BROWNOUT, or BLACKOUT.

4. The SD-WAN device of claim 1, wherein the first WAN connection comprises a satellite network communicatively connected with the Internet.

5. The SD-WAN device of claim 1, wherein the second WAN connection comprises a wireless cellular network communicatively connected with the Internet.

6. The SD-WAN device of claim 1, further comprising:
a network interface communicatively connected to the first remote host.

7. The SD-WAN device of claim 1, wherein the first remote host comprises one of a remote local area network (LAN) host, an Internet host, or a private network host.

8. A method for assigning a directional software defined wide area network (SD-WAN) transport/stream to SD-WAN packet traffic, comprising:
determining, by one or more processors, an applicable criteria for classification of each directional SD-WAN transport/stream in each SD-WAN tunnel being carried on two or more of a plurality of WAN transports between two or more SD-WAN devices, wherein the applicable criteria for classification comprises a set of packet traffic characteristics defining an operational status of a directional SD-WAN transport/stream;
monitoring, by the one or more processors, each of a plurality of active directional SD-WAN transport/streams in each SD-WAN tunnel being carried on the two or more of the plurality of WAN transports between the two or more SD-WAN devices;
calculating, by the one or more processors, an operational status for each of the plurality of active directional SD-WAN transport/streams based on the determined applicable criteria for classification; and
selecting, by the one or more processors, a directional SD-WAN transport/stream from among the plurality of active directional SD-WAN transport/streams to transmit outgoing SD-WAN packet traffic between the two or more SD-WAN devices, based on the calculated operational status of the selected active directional SD-WAN transport/stream.

9. The method of claim 8, wherein calculating, by the one or more processors, the operational status for each of the plurality of active directional SD-WAN transport/streams comprises:
assigning an operational status of CLEAN, BROWNOUT, or BLACKOUT to each of the plurality of active directional SD-WAN transport/streams.

10. The method of claim 9, wherein selecting, by the one or more processors, a directional SD-WAN transport/stream from among the plurality of active directional SD-WAN transport/streams to transmit outgoing SD-WAN packet traffic between the two or more SD-WAN devices, based on the calculated operational status of the selected active directional SD-WAN transport/stream comprises:
when one or more directional SD-WAN transport/streams are assigned an operational status of CLEAN, selecting one of the one or more CLEAN directional SD-WAN transport/streams to transmit the outgoing SD-WAN packet traffic according to application group preference.

11. The method of claim 8, wherein determining, by the one or more processors, the applicable criteria for classification of each directional SD-WAN transport/stream comprises:
selecting an applicable criteria of classification based on at least one of a direction of the outgoing SD-WAN packet traffic, an application of a connection of the outgoing SD-WAN packet traffic, a service class of the connection of the outgoing SD-WAN packet traffic, a transport mode (TM) of the connection of the outgoing SD-WAN packet traffic, a virtual private network (VPN) of the connection of the outgoing SD-WAN packet traffic, a type of the connection of the outgoing SD-WAN packet traffic, or a priority of the connection of the outgoing SD-WAN packet traffic.

12. The method of claim 8, wherein the two or more SD-WAN devices comprise at least one of an SD-WAN router or an SD-WAN gateway.

13. The method of claim 12, wherein the outgoing SD-WAN packet traffic is between a remote local area network (LAN) host communicatively connected with the SD-WAN router and at least one of a private network host communicatively connected with the SD-WAN Gateway or a public Internet host communicatively connected with the SD-WAN Gateway over the Internet.

14. The method of claim 8, wherein the two or more of a plurality of WAN transports between the two or more SD-WAN devices comprises at least a first WAN transport over a satellite network communicatively connected with the Internet and a second WAN transport over a wireless cellular network communicatively connected with the Internet.

15. The method of claim 14, wherein the satellite network comprises a high throughput satellite (HTS) network and the wireless cellular network comprises a long term evolution (LTE) cellular telephone network.

16. A non-transitory computer-readable storage medium storing machine-readable executable instructions, which when executed instructs one or more processors to:
receive a plurality of packets to transmit in a software defined wide area network (SD-WAN) communication connection between a first remote host communicatively connected to an SD-WAN router and a second remote host communicatively connected to an SD-WAN gateway,
wherein the SD-WAN router and the SD-WAN gateway are communicatively connected over a first WAN connection and a second WAN connection,
wherein the SD-WAN router and the SD-WAN gateway maintain the SD-WAN communication connection over one or more first SD-WAN tunnels on the first WAN connection and one or more second SD-WAN tunnels on the second WAN connection,
wherein each of the one or more first SD-WAN tunnels comprises a directional SD-WAN transport/stream in a first direction and a directional SD-WAN transport/stream in a second direction,
wherein each of the one or more second SD-WAN tunnels comprises a first directional SD-WAN transport/stream in the first direction and a second directional SD-WAN transport/stream in the second direction, and
wherein the first direction is from the SD-WAN router to the SD-WAN gateway and the second direction is from the SD-WAN gateway to the SD-WAN router;
determine whether a transmission direction of the plurality of packets is in the first direction or in the second direction;
determine an application group of the plurality of packets;
select a set of packet traffic characteristics which define an operational status of a directional SD-WAN transport/stream, based on the determined application group;
determine an operational status of directional SD-WAN transport/streams in the determined direction of each of the one or more first SD-WAN tunnels and each of the one or more second SD-WAN tunnels, based on the selected set of packet traffic characteristics; and
select a directional SD-WAN transport/stream to transmit the plurality of packets in the determined direction, based on its determined operational status.

17. The non-transitory computer-readable storage medium of claim 16, wherein the first WAN connection comprises a satellite network and the second WAN connection comprises a wireless cellular network.

18. The non-transitory computer-readable storage medium of claim 16, wherein the one or more processors are to determine an application group of the plurality of packets by:
determining whether the SD-WAN communication connection of the plurality of packets is interactive or for bulk transfer.

19. The non-transitory computer-readable storage medium of claim 16, wherein the one or more processors are to determine the operational status of the directional SD-WAN transport/streams in the determined direction by:
assigning an operational status of CLEAN, BROWNOUT, or BLACKOUT to each of the directional SD-WAN transport/streams in the determined direction.

20. The non-transitory computer-readable storage medium of claim 19, wherein the one or more processors are to select the directional SD-WAN transport/stream to transmit the plurality of packets in the determined direction based on its determined operational status by:
when one or more directional SD-WAN transport/streams are assigned an operational status of CLEAN, selecting one of the one or more CLEAN directional SD-WAN transport/streams according to application group preference.
